(19) United States
(12) Patent Application Publication
(10) Pub. No.: US 2025/0127328 A1
(43) Pub. Date: Apr. 24, 2025

(54) System and Method for Autonomously Cooking Food Products

(71) Applicant: Gastronomous Technologies Inc., Oakville (CA)

(72) Inventors: Kevork SEVADJIAN, Oakville (CA); Andrew SKREPNEK, Burlington (CA); Kristian TAZBAZIAN, Oakville (CA)

(73) Assignee: Gastronomous Technologies Inc., Oakville (CA)

(21) Appl. No.: 18/990,881

(22) Filed: Dec. 20, 2024

Related U.S. Application Data
(63) Continuation of application No. PCT/CA2023/050894, filed on Jun. 29, 2023.
Application No. PCT/CA2023/050894 is a continuation-in-part of application No. 17/810,137, filed on Jun. 30, 2022.
(60) Provisional application No. 63/491,979, filed on Mar. 24, 2023.
(60) Provisional application No. 63/501,178, filed on May 10, 2023.

(30) Foreign Application Priority Data
Jun. 29, 2022 (CA) 3166189

(51) Int. Cl. A47J 36/32; A47J 37/06; A47J 37/07

(52) U.S. Cl. CPC A47J 36/321; A47J 37/0676; A47J 37/0682; A47J 37/0786; A47J 2202/00

(57) ABSTRACT

The autonomous cooking grill comprises a grate or griddle connected to a rotatable hub which is connected to a hub rotating means, all supported by a grill body, wherein when the hub rotating means is activated the hub rotates the grate. In a further embodiment, the autonomous cooking grill comprises a griddle connected to a rotatable hub which is connected to a hub rotating means, all supported by a grill body, wherein when the hub rotating means is activated the hub rotates the griddle. The autonomous cooking grill can have one or more of the additional features of autonomous flipper(s), autonomous ejector(s), autonomous grate cleaner(s) and autonomous temperature probe(s), and bins to store cooked food products ejected from the grill. The features are utilized with suitable food products, such as patties. The autonomous cooking grill can use gas (or alternatively electricity) for cooking and use an electric actuator to turn the grate or griddle. The autonomous cooking grill may additionally comprise a cover to partially cover the grill or griddle. In a further embodiment, there is additionally a center grill for manually cooking food.

### CROSS-REFERENCE TO RELATED APPLICATIONS

This application is a Continuation of PCT Application No. PCT/CA2023/050894 filed on Jun. 29, 2023, which claims priority to Canadian Patent Application No. 3,166,189 filed on Jun. 29, 2022, U.S. patent application Ser. No. 17/810,137 filed on Jun. 30, 2022, U.S. Provisional Application No. 63/491,979 filed on Mar. 24, 2023, and U.S. Provisional Application No. 63/501,178 filed on May 10, 2023, the contents of all such applications being incorporated herein by reference in their entirety.

### TECHNICAL FIELD

The following relates to a system and method for autonomously cooking food products, in particular using a cooking grill, and more particularly a cooking grill for autonomously cooking food, for example in commercial kitchen environments.

### BACKGROUND

Standalone cooking grills for commercial kitchens (e.g., restaurant, mobile kitchens, food trucks, etc.) are typically gas-powered, electric-powered, infrared-powered; using radiant, convection, or induction heating; and using stainless steel or similar material, in a square or rectangular shape, with a grate of a corresponding shape. Such grills may be used for cooking various foods. Drawbacks to using such grills include: human error while cooking, inattention, difficulty with accurate quality control, and inconsistencies; non-uniform heating; and heat loss. Attempt have been made to address these issues, for example, portable smokeless charcoal charbroilers enclosed cooking grills with waste heat recovery; and other systems that use a broiler with even heat distribution.

However, these grills require a person to manually input what type of food is being cooked, flip a food product (e.g., burger), measure the temperature for safety, and clean the grill. Moreover, the design may be limited in terms of flexibility, with only a few pieces of the same food product being cooked at once. U.S. Pat. No. 9,788,687 dated Oct. 17, 2017, describes a system for cooking a burger without requiring a person to flip the burgers, which has individual upper plate and lower plate for each patty and conveyors for moving the patties. This takes up more room than a typical grill due to the conveyancing systems and does not provide for flipping patties on a grill with the desirable grill marks on the cooked patties. U.S. Pat. No. 7,997,189 describes an oven and broiler for cooking foods using convection and radiant heat, including a housing defining a cooking chamber with an inlet for introducing uncooked foods into the cooking chamber, an outlet for discharging cooked foods and a conveyor for conveying food product from the inlet to the outlet, an array of heating elements, and a compressed air injection system for providing a bank of moving air over the food product during the early stages of cooking so as to break up the blanket of cold air over the food product. Such systems are found to be inflexible in that one may be limited to only a few types of food at once due to the limited number of conveyors. Moreover, these systems are unable to flip the food product such that grill marks (if any) are only applied to one side.

US Publication No. 2014/0023755 provides a clamshell grill having a user interface that enables the user to select an initial cooking recipe for a food product, by determining an actual product thickness of the food product, determining if the actual product thickness of the food product is greater than or less than the cooking recipe's product thickness, and if the actual product thickness of the food product is greater than or less than the cooking recipe's product thickness, then executing a modified cooking recipe to accommodate a change in the actual product thickness during a cooking cycle. The modified cooking recipe then adjusts at least one parameter of the initial cooking recipe. However, the clamshell type grill is also found to be inflexible in that a fixed number of sections limiting the number of different types of food product that can be cooked at the same time. Moreover, the clamshell type does not accommodate an open flame, which is desirable for many types of food.

Other apparatus is available for autonomizing kitchen work, including robotic arms of various manufacturers including FANUC™ Corporation of Japan which includes multiple electric motors to provide motion and UR5e™ of Universal Robots.

### SUMMARY

An autonomous cooking grill is provided that autonomously cooks food safely, reliably and efficiently. The autonomous cooking grill includes a rotating cooking surface which includes one or more grates, and has a processor, a user interface, a flipping station, a temperature-probing station, an ejecting station, and a cleaning station, that uses a detection system to recognize the food product, then executes a cooking procedure based on the type of food product recognized.

In an embodiment, there is provided an autonomous cooking grill comprising: a body supporting a grate with at least one heat source directed towards or coupled to the grate, the grate and at least one tool being moveable relative to one another such that a portion of the grate can be aligned with the at least one tool according to a cooking sequence.

In certain example embodiments, the grate rotates relative to the at least one tool.

In certain example embodiments, a plurality of tools are spaced about the grate.

In certain example embodiments, the at least one tool comprises at least one autonomous flipper.

In certain example embodiments, the at least one tool comprises at least one autonomous ejector.

In certain example embodiments, the at least one tool comprises at least one autonomous grate cleaner.

In certain example embodiments, the at least one tool comprises an autonomous temperature probe.

In certain example embodiments, the grill further comprises an additional cooking surface centrally positioned in a hub surrounded by the grate.

In certain example embodiments, the at least one heat source comprises at least one gas burner to heat the grate.

In certain example embodiments, the at least one heat source comprises at least one electric heat source.

In certain example embodiments, the at least one heat source comprises both gas and electric heat sources.

In certain example embodiments, the additional cooking surface is heated by a first heat source that is different from a second heat source used to heat the grate.

In certain example embodiments, the first heat source is electric and the second heat source is gas. In certain example embodiments, the grill further comprises a bin capable of holding food.

In certain example embodiments, the grill further comprises a main controller coupled to a plurality of signal inputs and actuator controllers to control actuators and send outputs based on signal inputs.

In certain example embodiments, the main controller is coupled to a detection system to apply a food item recognition program as an input to determine a cooking algorithm.

In certain example embodiments, the grill further comprises a user interface coupled to a control system used in operating the grill.

In certain example embodiments, the grill further comprises at least one data interface to provide cooking log data.

In certain example embodiments, the grill comprises a network data interface for sending log data to a central server.

In certain example embodiments, the grill further comprises an indexing mechanism to determine a position of the rotatable grate.

In certain example embodiments, the grill further comprises a wall positioned on an underside of the body below the grate, the wall separating a relatively hot zone comprising the at least one heat source from a relatively cool zone aligned with areas comprising the at least one tool surrounding the grate.

In certain example embodiments, the at least one heat source is fed by a fuel source, the fuel source being regulated by a modulating valve, the modulating valve being computer controlled and being connected to an inlet fuel line, wherein a heat sensor is configured to measure a temperature of at least a portion of the grate, the temperature being used to control the modulating valve.

In certain example embodiments, the heat sensor provides a temperature reading to a controller and the controller uses the temperature reading to control the modulating value to vary an amount of fuel being delivered to each of the at least one heat source to increase or decrease the temperature of the grate.

In another aspect, there is provided a system comprising at least one autonomous cooking grill as defined above; a network interface coupled to each of the at least one autonomous cooking grill to obtain data generated by each grill; and a central server coupled to each cooking grill via a respective network interface to exchange data with the respective grill.

In another aspect, there is provided a method comprising: detecting placement of food to be cooked on an autonomous cooking grill as defined above; detect type of food product; determine a cooking algorithm per detected type of food product; and rotate grill according to cooking algorithm.

In certain example embodiments, the method further comprises: when cooking has completed, rotate to an ejection zone if necessary and activate an ejector tool.

In certain example embodiments, the method further comprises aligning the food product with a flipper tool and flipping the food product at an indicated time during the cooking algorithm.

In certain example embodiments, the method further comprises aligning the food product with a temperature probe to determine a temperature of the food product during execution of the cooking algorithm.

In certain example embodiments, the method further comprises aligning a grate on which the food product was placed with a scraper tool and activating the scraper tool to clean the grate for a next cooking iteration.

In certain example embodiments, the method further comprises aligning the food product with a particular warming bin according to the type of food product.

In another aspect, there is provided a computer readable medium comprising computer executable instructions for performing the method as defined above.

In another aspect, there is provided an autonomous cooking grill comprising a body supporting a grate with at least one heat source directed towards or coupled to the grate, the grate being rotatable in a clockwise and/or counterclockwise direction.

### BRIEF DESCRIPTION OF THE FIGURES

Embodiments will now be described with reference to the appended drawings wherein:

FIG. 1a is a perspective view of an autonomous cooking grill.

FIG. 1b is a perspective view of an autonomous cooking grill in another configuration.

FIG. 1c is a front view of an autonomous cooking grill in yet another configuration.

FIG. 1d is a front view of the autonomous cooking grill shown in FIG. 1b in comparison to the height profile of the configuration shown in FIG. 1c.

FIG. 1e is side view of the configuration shown in FIG. 1c.

FIG. 1f is a side view of the configuration shown in FIG. 1b.

FIG. 2a is a top view of the cooking grill of FIG. 1.

FIG. 2b is a schematic plan view of one example of a configuration for enabling relative movement between a cooking surface and one or more tool features.

FIG. 2c is a schematic plan view of another example of a configuration for enabling relative movement between a cooking surface and one or more tool features.

FIG. 2d is a schematic elevation view of a presence detection system using a light curtain beam to detect the presence of an operator in a cooking zone.

FIG. 2e is a perspective view of an imaging system for detecting a food product loaded into the cooking zone.

FIG. 3 is a front view of the cooking grill of FIG. 1.

FIG. 4 is a left side view of the cooking grill of FIG. 1.

FIG. 5a is a perspective view of a grill body of a cooking grill.

FIG. 5b is a top view of the grill body of FIG. 5a.

FIG. 5c is a front view of the grill body of FIG. 5a.

FIG. 5d is a left side view of the grill body of FIG. 5a.

FIG. 5e is a perspective view of an indexing system for detecting a position of a rotatable grill relative to one or more tool features.

FIG. 6a is an exploded view of the cooking grill of FIG. 1a.

FIG. 6b is a side view of an autonomous cooking grill showing an alternative positioning of food product collection bins according to what is illustrated in FIG. 1b.

FIG. 6c is a partial front view of the autonomous cooking grill shown in FIG. 6a illustrating a side view of the food product collection bins in that configuration.

FIG. 7a is a perspective view of a heating system of an autonomous cooking grill.

FIG. 7b is a schematic view showing a gas distribution system for a set of grill burners.

FIG. 7c is a schematic view showing an electrical distribution for an ignition system for the set of grill burners shown in FIG. 7b.

FIG. 7d is a top perspective view of a computer-controlled fuel delivery and control system for an autonomous cooking grill, shown in isolation.

FIG. 7e is bottom perspective view of the underside of an autonomous cooking grill to illustrate a heat management system utilizing a double firewall.

FIG. 8a is a perspective exploded view of a grate system of an autonomous cooking grill.

FIG. 8b is a plan view of a set of grates in one configuration.

FIG. 8c is a plan view of a set of grates in another configuration.

FIG. 8d is a plan view of an individual grate in isolation.

FIG. 8e provides a comparative view of varying chassis dimensions that are alterable to utilize different placement footprints.

FIG. 9a is a perspective view of one example of a flipping system of an autonomous cooking grill.

FIG. 9b is an exploded perspective view of the flipping system of FIG. 9a.

FIG. 9c is an uncovered perspective view of another example of a flipping system of an autonomous cooking grill.

FIG. 9d is a side view of the flipping system of FIG. 9c.

FIG. 9e is a perspective view of the flipping system of FIG. 9c in operation.

FIG. 10a is a perspective view of an example of an extendable ejector system of a cooking grill.

FIG. 10b is an exploded perspective view of the extendable ejector system of FIG. 10a.

FIG. 10c is a perspective view of a lifter-type ejector system.

FIG. 10d is a perspective view of the lifter-type ejector system of FIG. 10c in operation.

FIG. 11a is an exploded perspective view of one example of a cleaner system of an autonomous cooking grill.

FIG. 11b is a perspective view of the cleaner system of FIG. 11a an idle position.

FIG. 11c is a perspective view of another example of a cleaner system of an autonomous cooking grill.

FIG. 12a is a perspective view of one example of a temperature probe system of an autonomous cooking grill.

FIG. 12b is a perspective view of the temperature probe system of FIG. 12a in an idle position.

FIG. 12c is a perspective view of the temperature probe system of FIG. 12a in a probing position.

FIG. 12d is a perspective view of another example of a temperature probe system of an autonomous cooking grill.

FIG. 12e is a perspective view of the temperature probe system of FIG. 12d in operation.

FIG. 12f is a perspective view of yet another example of a temperature probe system of an autonomous cooking grill.

FIG. 13 is a perspective view of an autonomous cooking grill of a further embodiment.

FIG. 14 is a perspective view of the top of an autonomous cooking grill of a further embodiment.

FIG. 15 is a top view of the autonomous cooking grill of FIG. 14 with modifications.

FIG. 16 is an aerial perspective view of the autonomous cooking grill of FIG. 1b illustrating one arrangement of tool features around an indexing rotatable cooking grill.

FIG. 17 is a schematic illustration of a connected system for logging operations of a plurality of cooking locations having at least one autonomous cooking grill.

FIG. 18 is a schematic illustration of one example of a control system for operating an autonomous cooking grill.

FIG. 19 illustrates operations performed by an autonomous cooking grill in operation, in one example programming configuration.

### DETAILED DESCRIPTION

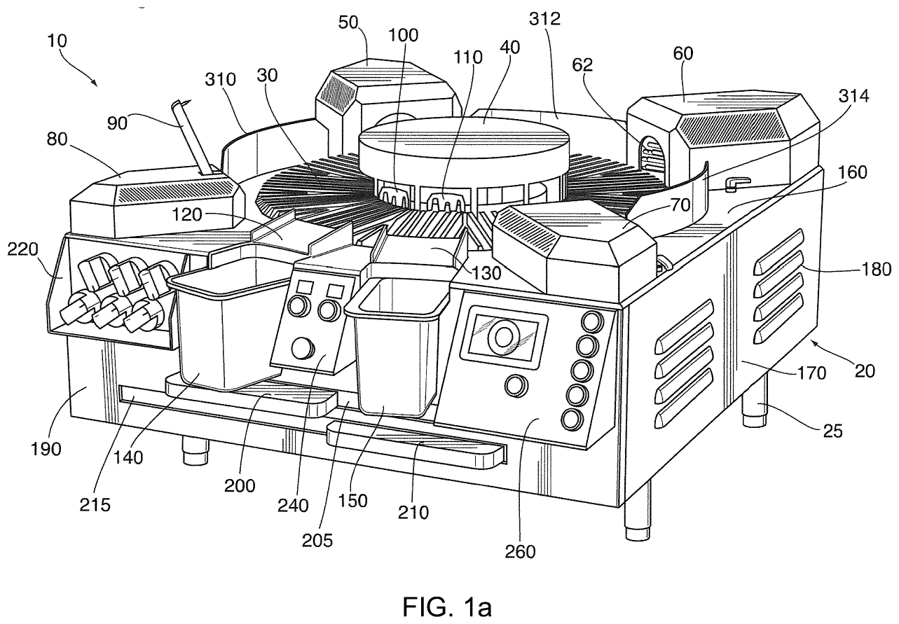

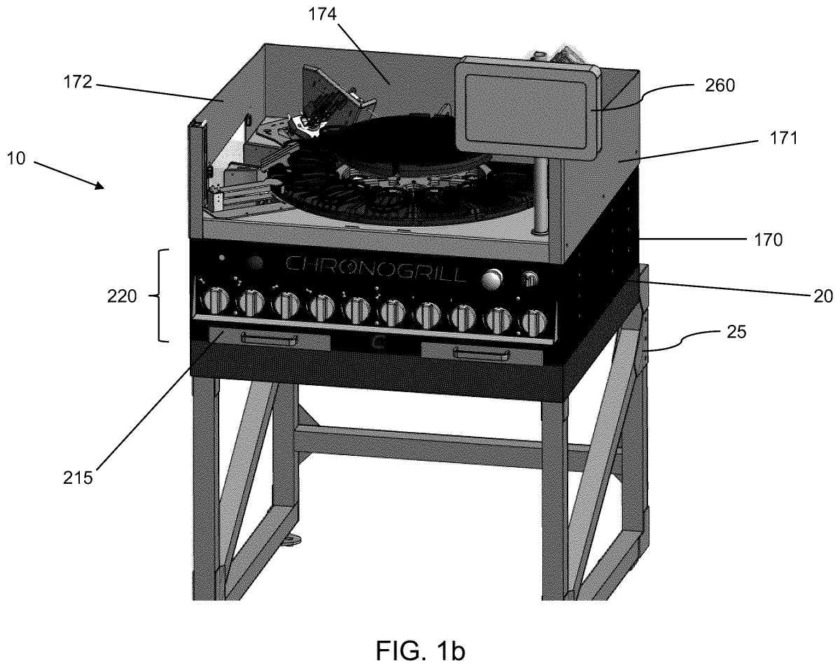

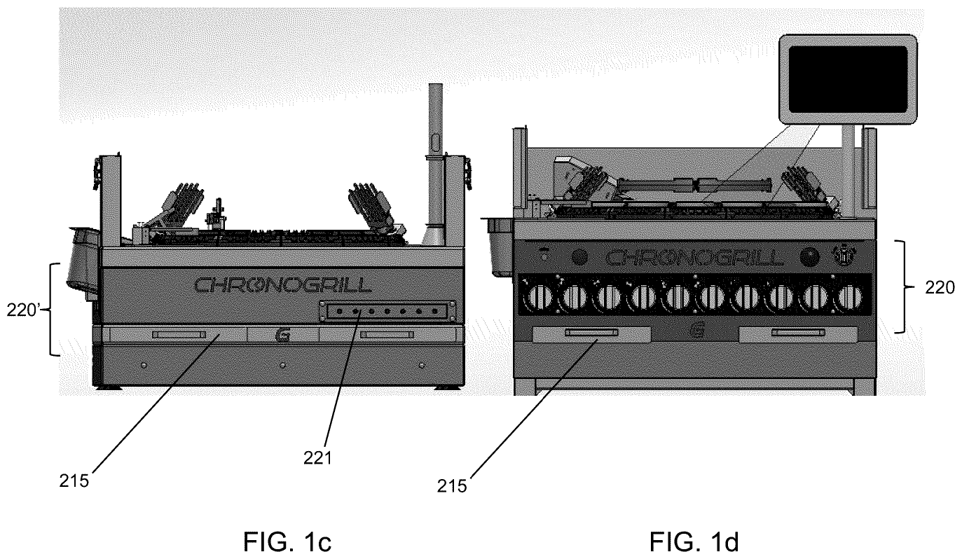

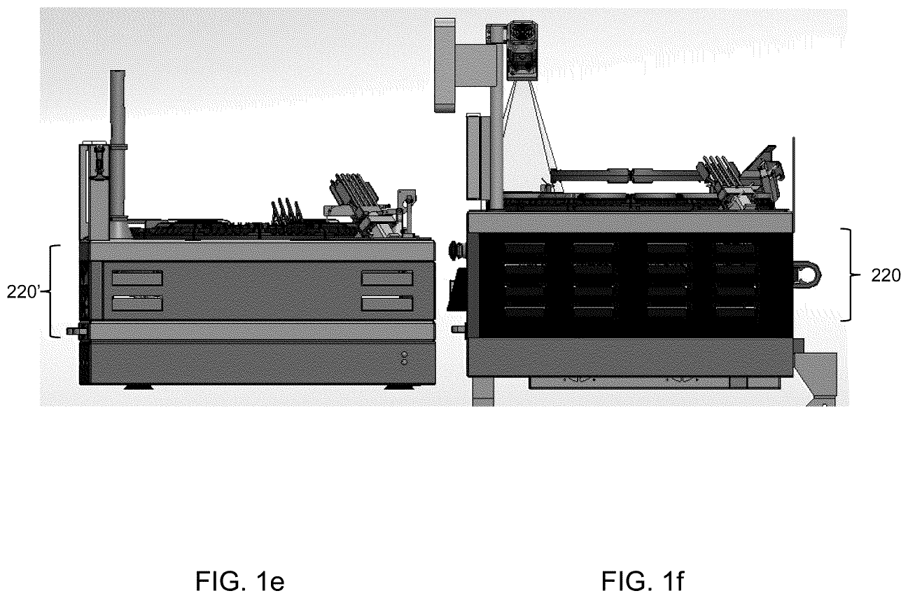

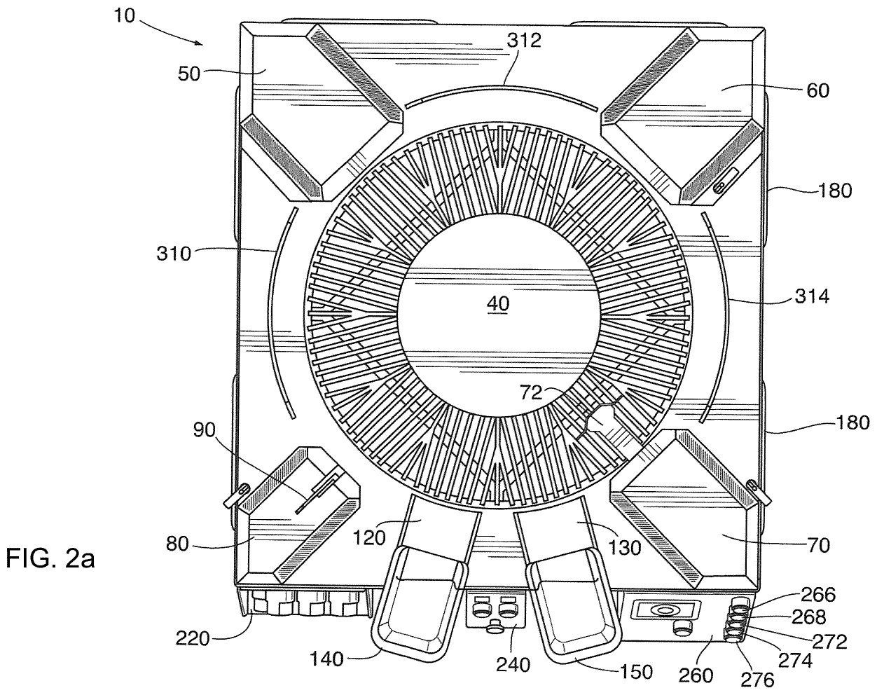

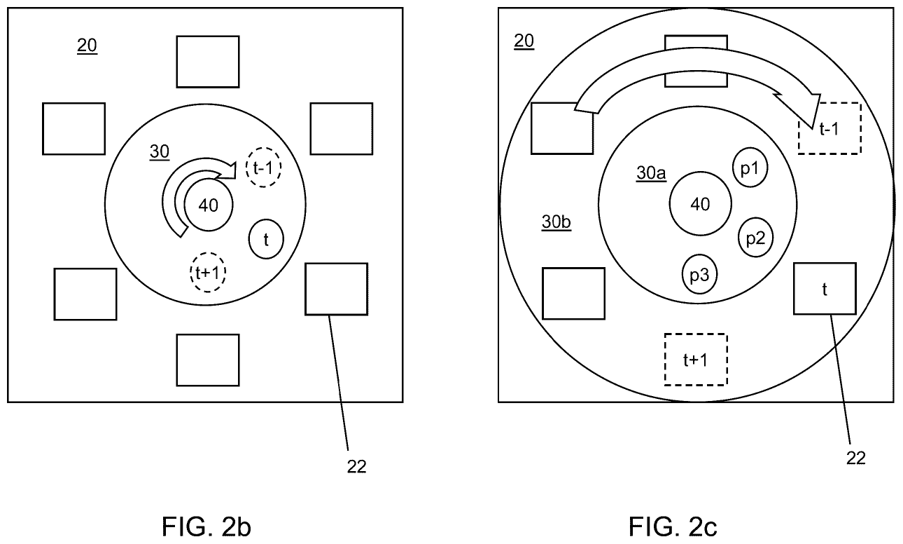

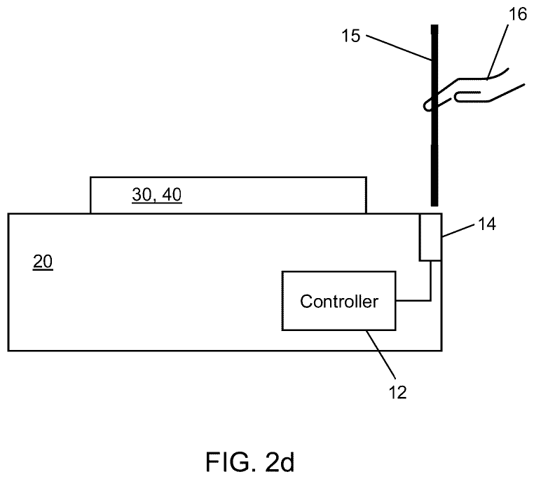

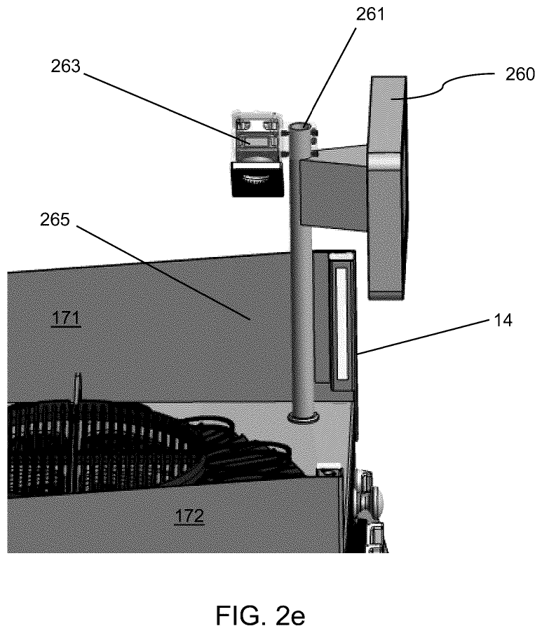

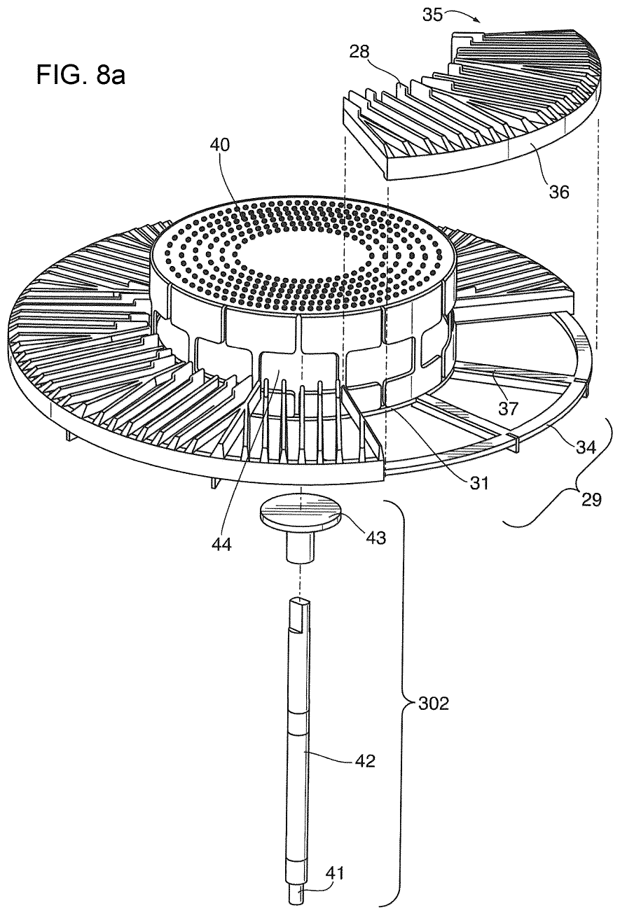

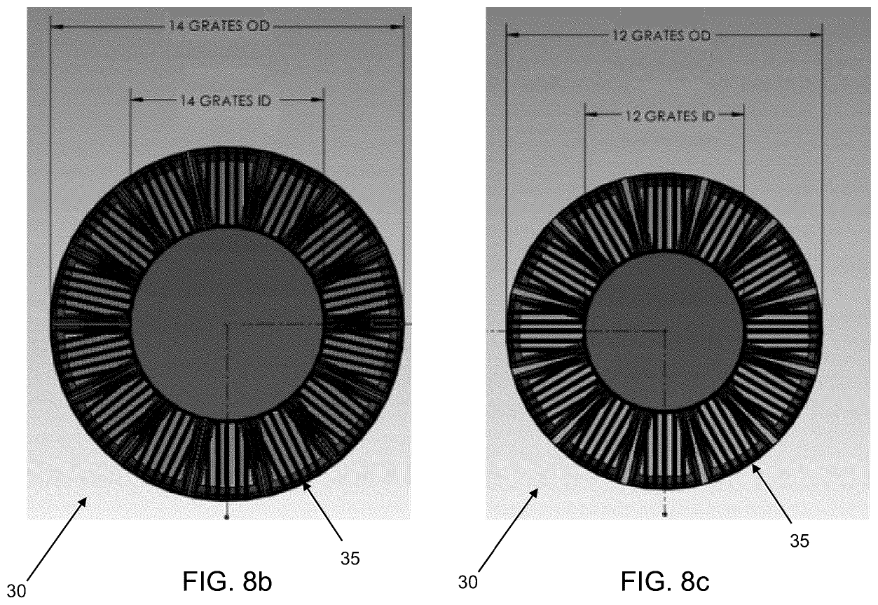

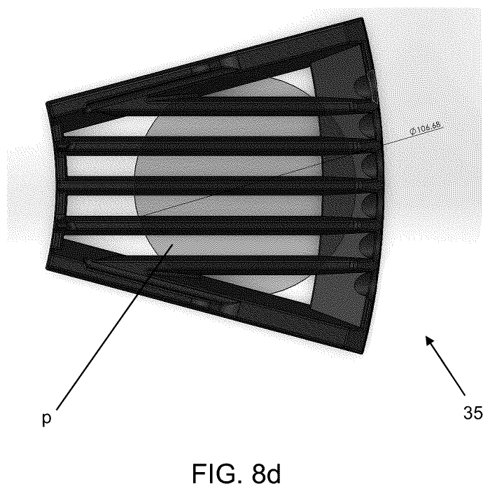

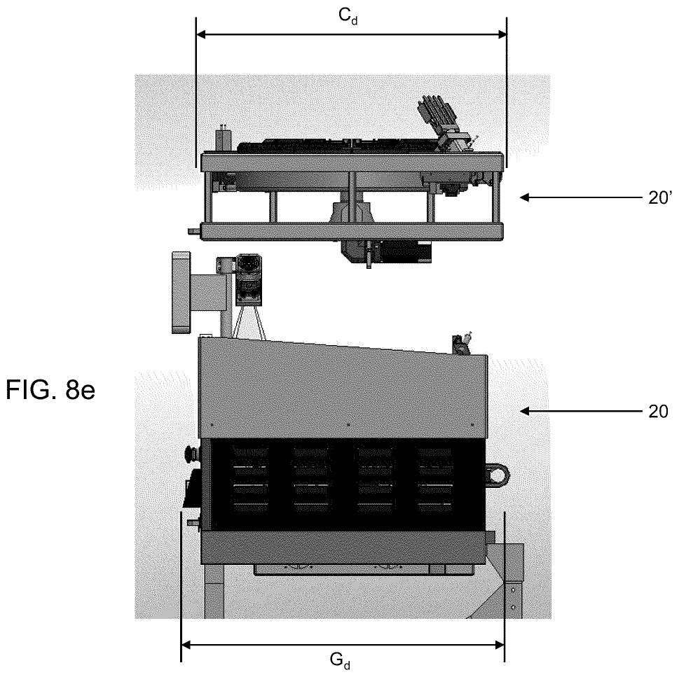

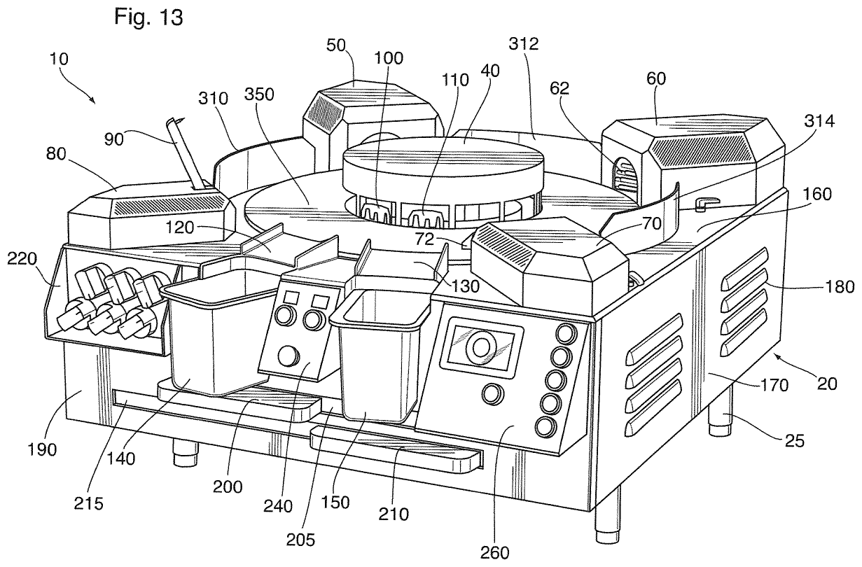

As shown in FIGS. 1a and 2a, an autonomous cooking grill 10 is provided, which comprises a cooking surface such as a grate 30 (or griddle 350, shown as a solid metal sheet in FIG. 13) in the center, a rotatable hub 40, and a hub rotating mechanism 39 (shown in FIG. 8), all supported by a grill body 20, in which the grate 30 (or griddle 350) is supported by a frame 29 connected to the hub 40, the hub rotating mechanism 39 (not shown) is connected to the hub 40, and wherein when the hub rotating mechanism 39 is activated the hub 40 rotates the grate 30 (or griddle 350). In an alternative embodiment the grate 30 (or griddle 350) may be rotated by an external gear system. While the rotatable hub 40 in this example is used to rotate the grate 30 relative to surrounding tool features 22 (see also FIG. 2b), the hub 40 may also be held stationary relative to the grate 30 such that a central cooking surface is positioned within the surrounding grate 30 that moves about the hub 40. As such, the hub 40 may represent a component of the rotatable grate 30 or a separate component that may rotate relative thereto as described further below. Moreover, while a generally circular grate 30 and hub 40 are shown, any shape can be utilized so long as it can be indexed relative to additional tool features 22.

The autonomous cooking grill 10 can have one or more of the additional tool features 22, such as one or more autonomous flipper(s) 62, one or more autonomous ejector(s) 100, 110, an autonomous grate cleaner 72, and an autonomous temperature probe 90. It can be appreciated that other tool features 22 not shown in FIGS. 1a and 1b and elsewhere can be incorporated, for example, autonomous entry, loading, removal, etc. With these additional tool features 22, the autonomous cooking grill 10 can grill suitable food products, autonomously flip the food product, measure the internal temperature, eject the food product off the grate 30, and clean the portion of the grate 30 on which the food product was placed. In further embodiments, various combinations of the above features can be implemented. In an embodiment, these tool features 22 can be combined into one or more tools each having a plurality of tool features 22. While examples provided herein illustrate that the autonomous cooking grill 10 can use gas for cooking and use an electric actuator (not shown) to turn the grate, it can be appreciated that other heating sources such as electric induction may be used.

In an embodiment seen in FIGS. 1a, 2a, 3, 4, 5a-5d, and 6a, there is an autonomous cooking grill 10 comprising a rotating grate 30 in a grill body 20. On the outside periphery of the grate 30 is a first flipper housing 60 and a second flipper housing 50, each of which houses a flipper 62. Alternatively, there could be one flipper 62 with a tool changer capability e.g. from a meat flipper to a veggie flipper. In the embodiment shown in FIG. 1a, there is also a grill cleaner housing 70, which houses a grill cleaner 72, and a temperature probe housing 80 having a temperature probe 90 with a thermometer 92. In an alternative embodiment, one or more of the flipper(s) 62, grill cleaner 72 and temperature probe 90 may be located in the center of the grate 30 or griddle 350, or above on a gantry style system.

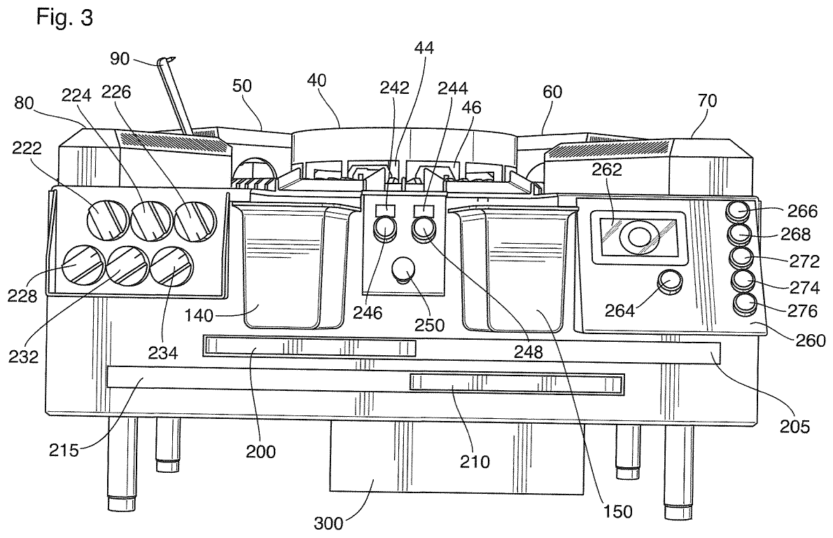

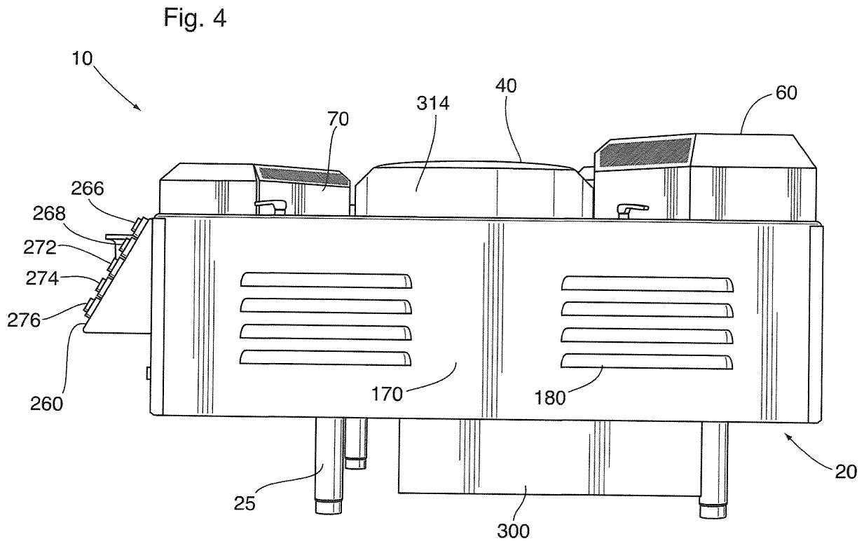

As seen in FIGS. 3 and 4, the grill body 20 can rest on legs 25 which are sized to raise the body 20 high enough to accommodate an actuator (not shown) or any other mechanisms positioned below and/or within the actuator cover 300, that is, underneath the grill body 20.

As seen in the example configuration shown in FIG. 1a, in the hub 40 there are ejector openings 44 through one of which can be seen a first ejector face 100 and through another ejector opening 44 can be seen a second ejector face 110. Across from the first ejector face 100 is a first ejector ramp 120 which ends in a first bin 140. Across from the second ejector face 110 is a second ejector ramp 130 which ends in a second bin 150. The ejector faces 100, 110 are identical in this embodiment, but could be differentiated for different food products.

In an alternative embodiment, instead of the ejector(s) described above, one or more further tools (e.g., embodied as flippers 62) may be used which lift and drop food into the bin 140, 150 rather than push it in. In a further alternative embodiment, instead of the ejector(s) described above, the flipper 62 which flips the food also acts as an ejector by scooping up the food but, instead of flipping it, the flipper 62 pivots and drops the food product in a bin 140, 150. As such, the flipper 62 which also acts to “eject” the food into a bin may be placed closer to the bins or the bins moved closer to the flipper 62. In yet another embodiment, a tool changer capability can be provided, such that one mechanism can flip, eject, temperature probe and clean. That is, a set of tool features 22 may be interchangeable with a common base portion with a quick connect or other attachment mechanism to allow the grill 10 to autonomously (and/or manually) swap out the tool feature “heads” as needed to perform the different functions. This may be advantageous, for example, in a grilling zone that has a smaller footprint or area within to work. Such a swapping feature can be implemented using any additional robotic or manual functionality, such as a “rolodex” of heads that are swappable by command.

FIG. 1b illustrates another example of a configuration for the autonomous cooking grill 10. In this example, the grill body 20 is supported by a frame. The frame in this example provides a set of legs 25 that are selected to have a height that positions the grate 30 and any other cooking surface (e.g., positioned at hub 40) at a desired height. The legs 25 can be adjustable, either manually or automatically. The legs 25 may also not be required, for example, if the grill 10 is placed on an existing countertop or other structure. The grill body 20 includes a set of control knobs 220 for individually controlling gas flow for individual burners or to individually control other heating elements that are used (e.g., induction elements). In other embodiments, control knobs may not be used, for example, an on/off switch could be coupled with an emergency stop button and a modulating/solenoid gas valve to control one, pairs, multiples, or all of the burners electronically. This allows the grill 10 to adjust the gas flow to one or more burners automatically, for example on/off to trigger full gas flow, or by using values to provide individual control of the gas flow to each burner (or a subset of burners). In this example, a user interface (UI) terminal 260 is supported above the grill body 20 so as to not obstruct a forward facing plane through which a food product can be loaded onto the grate 30. In this example, a right side heat shield panel 171 is provided, along with a rear panel 174 and an ejection side panel 172. Further features associated with the configuration shown in FIG. 1b will be described below.

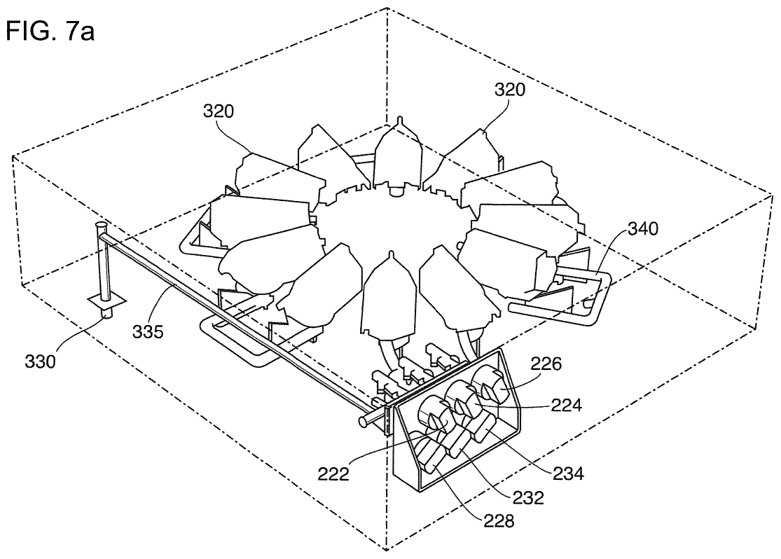

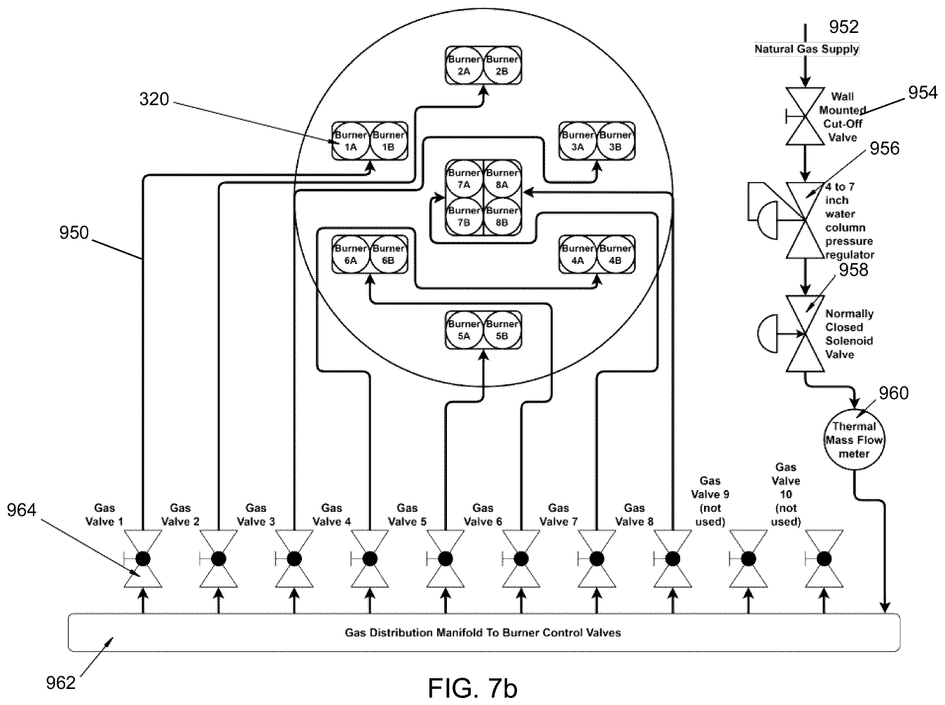

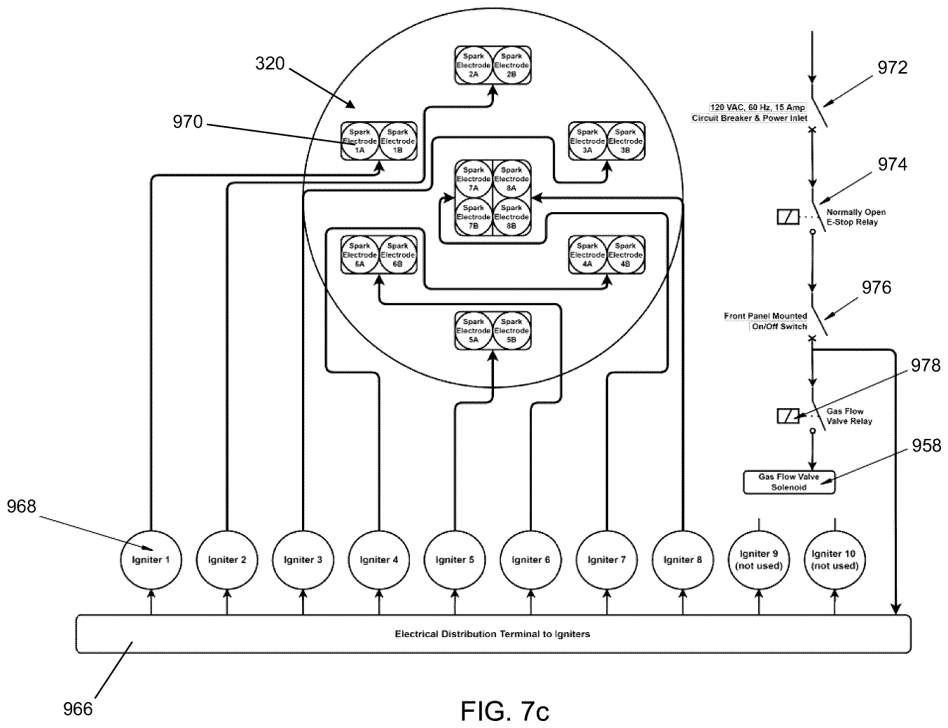

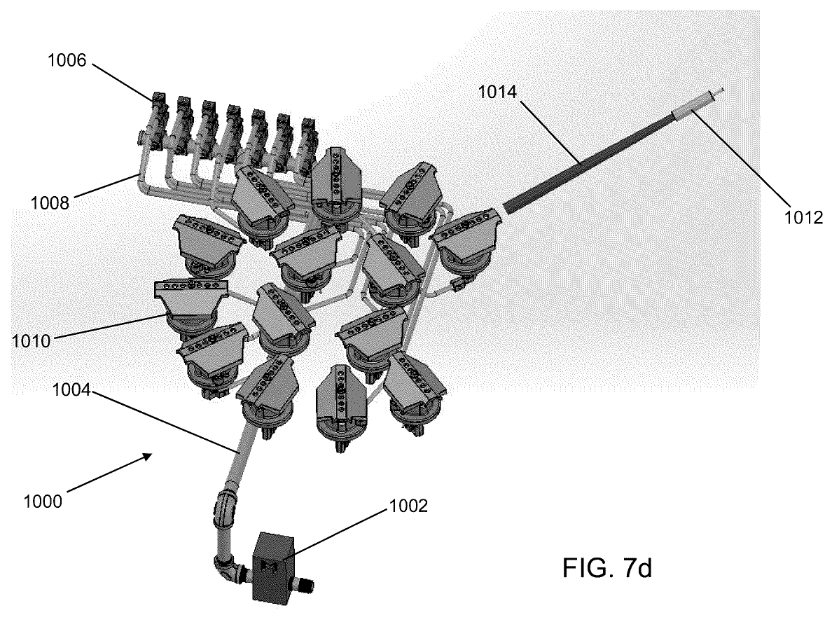

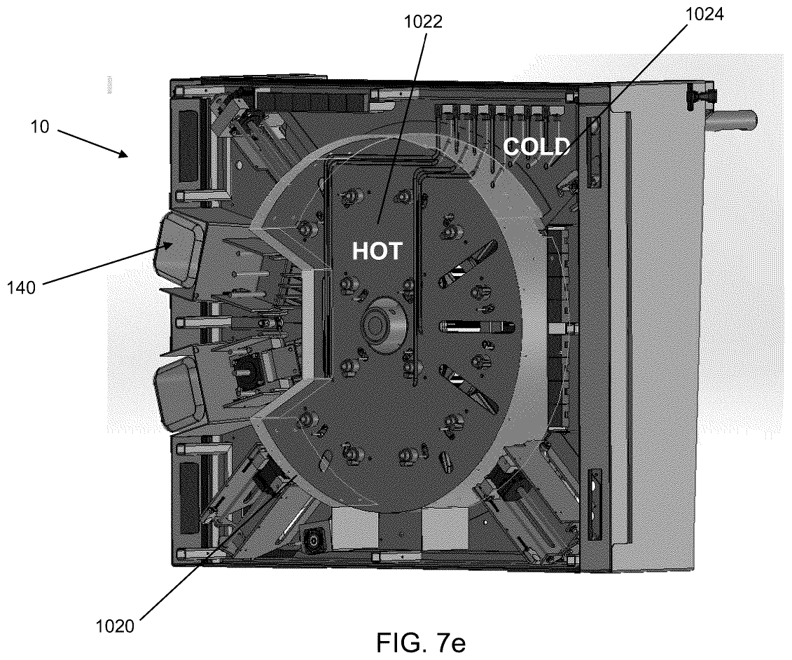

FIG. 1c illustrates another configuration for the autonomous cooking grill 10 having a lower profile than that shown in FIG. 1b, as illustrated side-by-side with the view shown in FIG. 1d. In the configuration shown in FIG. 1c, the panel of control knobs 220 can be eliminated when using a computer-controlled or otherwise non-manual gas flow control system, described later in reference to FIG. 7d. The overall height of the grill's body, as illustrated in the side-by-side comparison can be adapted to suit a particular existing countertop or working space. For example, the lower profile shown in FIG. 1c may allow relatively shorter personnel to more comfortably use the grill 10. On the other hand, a higher profile such as that shown in FIG. 1d may be required to better match the height of the grate 30 with an adjacent counter top. As such, which the elimination of the control knobs 220 allows for a lower profile, it may not necessarily be utilized. In such a case, additional space may be available under the grate 30 to accommodate the various mechanisms and tools discussed herein.

As seen in FIG. 2a, in that configuration, the hub 40 is surrounded by the grate 30, which is surrounded by the one or more tool features 22 that autonomously interact with food products being cooked upon the grate 30. That is, the grate 30 rotates relative to the tool features 22, which are held stationary. The hub 40 may be connected to the grate 30 and rotate with it, or as noted above, may itself remain stationary relative to the grate 30 and can be used to provide an additional cooking surface. This configuration and relative motion of the substantially concentric portions of the grill 10 can also be applied to the configuration shown in FIG. 1b. FIG. 2b illustrates this arrangement schematically, wherein the food products (p) rotate clockwise on the grate 30 while the hub 40 and tool features remain stationary. It can be appreciated that counter clockwise motion is also possible. As illustrated in FIG. 2b, at time t, the food product is positioned adjacent the tool feature 22 in the bottom righthand corner of the diagram, whereas at t−1 and t+1 the same food product is positioned at the prior and next tool feature respectively. It can be appreciated that other indexing can be used, for example, to move the food product to additional positions between tool features 22 and that each indexed position does not necessarily coincide with a next tool feature 22.

The relative movements shown in FIG. 2b are only one example. For example, as shown in FIG. 2c, the hub 40 and grate 30a may be held stationary while an outer platform 30b or other structure rotates about the grate 30a to move the tool features 22 to the food products (p) rather than vice versa. In this example, product p2 is held stationary such that the tool feature 22 interacting with it at time t was previously adjacent product p1 and will next be adjacent to product p3. It can be appreciated that the hub 40 can also be rotatable relative to the grate 30a and outer platform 30b in other configurations. That is, each of the grate 30, hub 40 and outer platform 30b may be rotatable such that various relative indexing can be applied.

It can also be appreciated that the tool features 22 can also be housed above the grate 30 and hub 40 and be deployed downwardly towards the cooking surface(s) to interact with the food products rather than rotate relative to such cooking surface(s). Similarly, each tool feature 22 may be housed beneath or otherwise outside of the cooking zone and be moved into the cooking zone when needed, e.g., when additional robotic articulation can be accommodated. Such capabilities can be employed when the autonomous cooking grill 10 is to be integrated with other autonomous kitchen equipment, such as preparation equipment, serving equipment, etc.

Referring now to FIG. 2d, a light source 14 is shown that is coupled to a controller 12 such that a beam or curtain of light 15 is used to detect the presence of an operator 16 or other object that is entering a “cooking zone” associated with the grate 30 and/or hub 40 as well as any surrounding area that may have moving parts, such a surrounding tool feature zone. The light curtain 15 can be generated such that an interruption to the beam or curtain of light triggers an input to the controller 12, e.g., to stop movement of the autonomous cooking grill 10 until the curtain 15 is restored or a manual input/override is detected. This provides an automated safety switch for the grill 10.

FIG. 2e illustrates an example implementation of such a light source 14 in the configuration shown in FIG. 1b. In this example, the light source 14 includes an emitter and detector positioned across an opening from each other between the sidewalls 171, 172. It can be appreciated that this is only one possible arrangement for the light source 14. Also shown in FIG. 2e is a mounting post 261 upon which the UI screen 260 is mounted. The mounting post 261 also provides a mechanism to support an imaging system 263 that is positioned with its field of view 265 directed towards a purported starting position on the grate 30 to enable the imaging system 263 to detect the presence of a new food product and performing image recognition or other computer vision techniques to identify the type of product to enable cook times and sequencing to be adjusted accordingly.

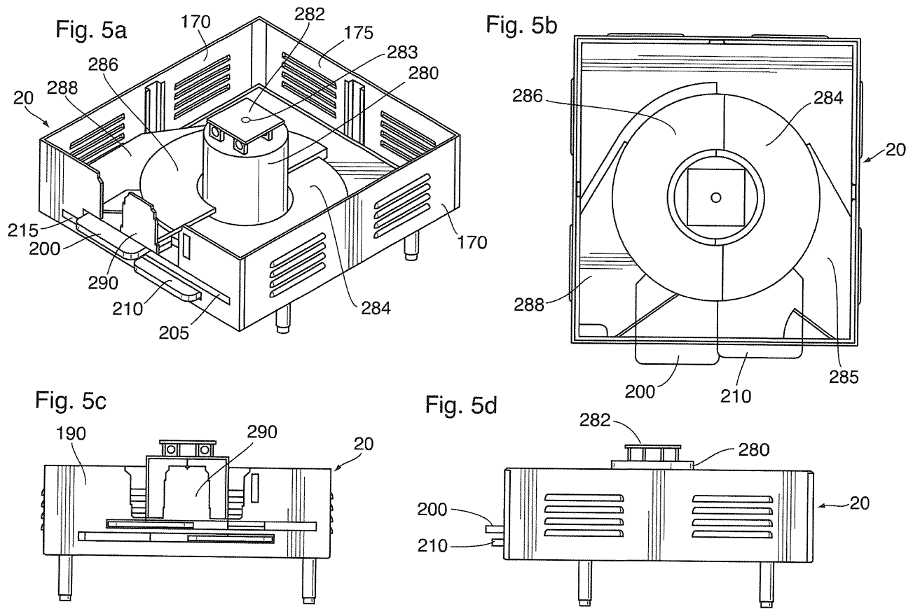

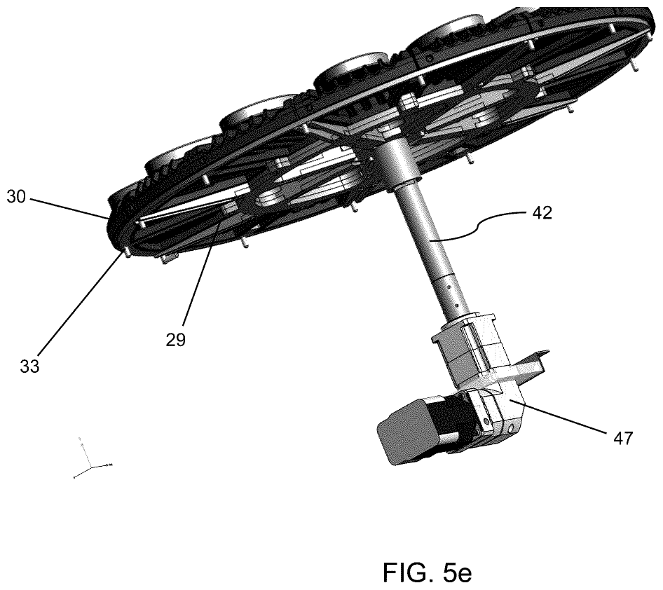

In the embodiment of FIG. 1a, as shown in FIGS. 5a to 5d, the grill body 20 may include a grill body top 160 (see FIG. 1a), grill body sides 170, grill body back 175 and grill body front 190. The grill body sides 170 and grill body back 175 have grill body vents 180. At the front of the grill body 20 there can be seen a first drip tray handle 200 and second drip tray handle 210 extending out from first drip tray slot 205 and second drip tray slot 215, respectively. In another embodiment there are four drip trays. It will be understood that the drip trays are for managing food product drippings which are a result of any food grilling and other ways of collecting drippings and food debris may be utilized. FIG. 1b illustrates another example in which a pair of trip tray slots 215 are positioned beneath the control knobs 220.

At the front of the cooking grill 10 shown in the embodiment of FIGS. 1a, 2a, and 3, there is a panel of gas knobs 220, an ejector system panel 240 and a main user panel, also referred to herein as a UI screen using numeral 260. As shown in FIG. 3, the ejector system panel has a first ejector counter 242, a second ejector counter 244, a first ejector reset button 246, a second ejector reset button 248 and an emergency stop button 250. The ejector system is optional since it may not be necessary for the system to count how many times food is ejected from the system, and alternatively this information can be collected with load and/or visual sensors and data collected remotely. The data can also be displayed on the UI screen 260. The main user panel 260 has a main user display 262, temperature probe maintenance button 264, as well as first to fifth food product selection buttons 266, 268, 272, 274, 276. The UI screen 260 may be on a stand for the grill or flip screen on the grill, or can be on a cart. The grill 10 can also be on a cart itself. As will be understood, the above components can be in different locations, can be in different configurations, can be operated by touch screen, can be operated on a remote or accessible with an App or computer program. With vision and or load sensors, button controls may be eliminated. Data may be collected for quality control purposes and/or for improving the cooking process. A touch-screen may be detachably coupled to the front, top or side of the autonomous cooking grill 10.

FIGS. 5a to 5d show the grill body 20 for the embodiment shown in FIG. 1a. To cover the ejectors 99 (not shown) there is an ejector plate 282, with an ejector plate opening 283, attached to the top of an ejector stand 280. The first drip tray 284 and second drip tray 286 rest on a first drip tray support shelf 285 and a second drip tray support shelf 288, respectively. The grill body front 190 has a middle grill body front segment 290 between the bins 140, 150.

FIG. 5e illustrates a rotating frame 29 for the embodiment shown in FIG. 1b, which supports the grate 30. The frame 29 is rotated via a shaft 42 controlled by a motor 47. In this example, a series of posts 33 project from the underside of the frame 29 at the interface of each station or section of the grate 30. In this way, an imaging system, magnetic switch, proximity sensor, light sensor, or other detector mechanism can be used to determine when the grate 30, upon rotation, has reached a next station. It can be appreciated that the posts 33 are only one example of an indexing detection mechanism that can be used to determine when a rotational operation should cease to enable a cook time or other operation to be performed at that location prior to further rotation of the grate 30. The frame 29 shown in FIG. 5e can also be adapted for use with the embodiment shown in FIG. 1a by modifying the outer ring 34 of the frame 29 accordingly (see FIG. 8).

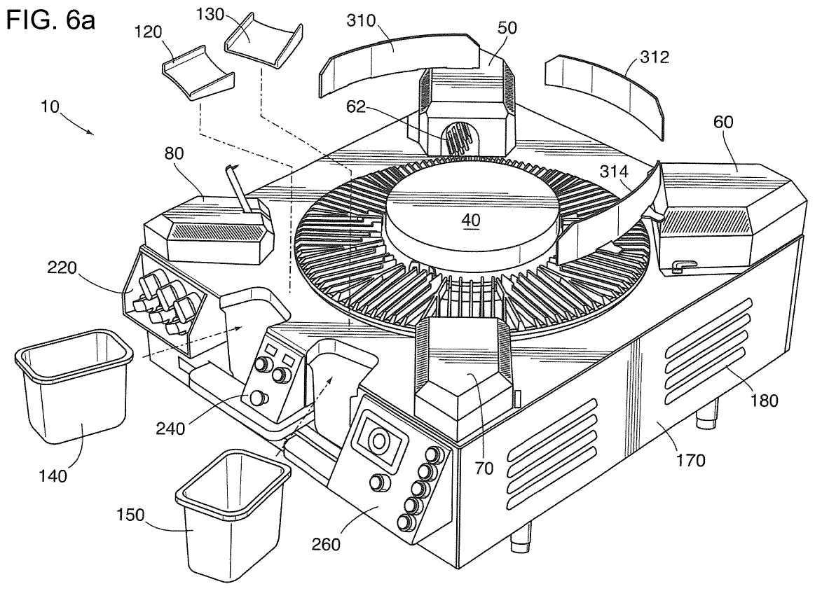

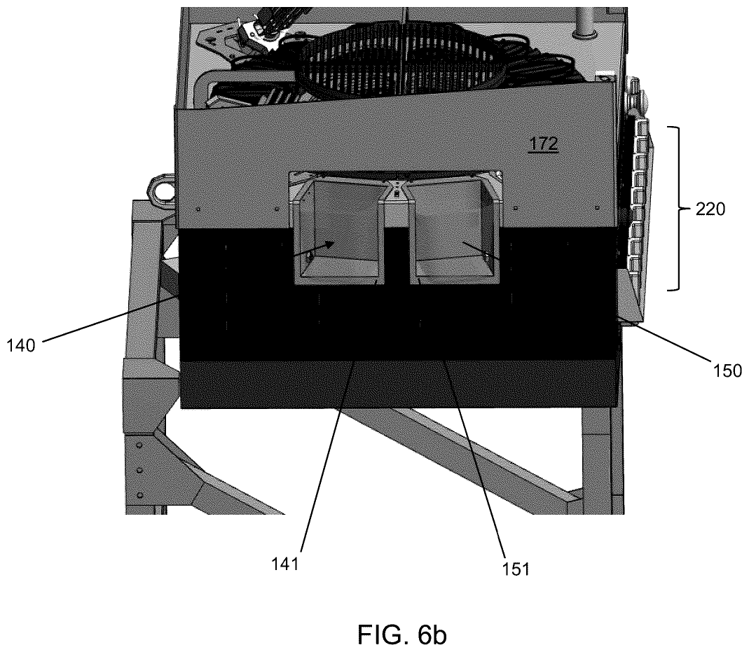

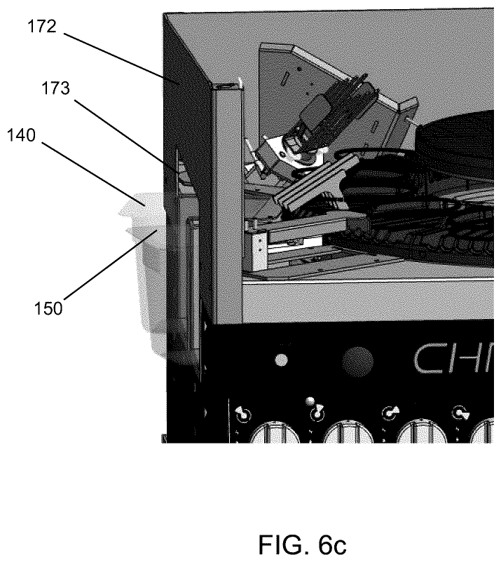

FIG. 6a shows the parts of the cooking grill of FIGS. 1a, 2a, 3 and 4 in an exploded view to show the first grill guard 310, second grill guard 312 and third grill guard 314 which provide an optional back up to catch any food from sliding off the grate 30 and capture some grease splatters. FIG. 6a also illustrates the bins 140, 150 that fit within pockets or recessed areas of the front portion of the grill 10 to align with the ejectors used in the embodiment shown in FIG. 1a.

FIG. 6b illustrates an alternative configuration according to what is shown in FIG. 1b, in which the bins 140, 150 are arranged along the sidewall 172 and fit into pockets 141, 151 respectively while protruding through an opening 173 as also seen in FIG. 6c. In this way, as food products are ejected into the bins 140, 150, the bins 140, 150 can be removed when appropriate without disrupting the operations occurring at the front of the grill 10.

FIG. 7a shows a heating system of a cooking grill 10 according to the embodiment shown in FIG. 1a, but which may also be adapted to be used in the embodiment shown in FIG. 1b. In this example, the gas burners 320 are supplied with gas that enters via a gas inlet 330, through gas inlet piping 335 and thereafter if one of gas knobs 222, 224, 226, 228, 232, 234, is opened to the respective burner's gas piping 340. It will be understood that there may be one gas burner or multiple gas burners (e.g., one aligned with each grate 30), as well as one or multiple controls for the gas burners or autonomously regulated heating from gas burner(s). Additionally, there may be one or more deflector or radiant shroud to distribute the heat, made from a variety of materials, such as, cast iron, stainless steel, or ceramic etc. Alternatively, there can also be a burner placed underneath such a shroud to create a heat vortex and to prevent grease build up.

Referring now to FIG. 7b, a schematic layout of a set of burners 320 is shown. The set of burners 320 provides a burner 320 aligned with each grate 30, with pairs of burners 320 being supplied by a common gas feed 950. That is, in this example arrangement, six pairs of burners 1A/1B, 2A/2B, 3A/3B, 4A/4B, 5A/5B, and 6A/6B are located about the periphery of the grill 10, with a further two pairs of burners 7A/7B and 8A/8B aligned with a central stationary grill 40, 400. By having multiple burners 320, in this case one aligned with each grate 30, at any given point in the rotation of the autonomous grill 10, a more even distribution of heat can be provided that avoids both cool and hot spots. Moreover, having individual burners 320 provides an ability to individually control the amount of heat delivered to any specific grate 30, thus providing additional control and programmability based on the cooking times required, the food product being cooked, or other factors such as ambient temperatures, etc.

In the configuration shown in FIG. 7b, a natural gas supply 952 feeds into a wall-mounted cut-off valve 954, which feeds into a pressure regulator 956. The pressure regulator 956 feeds into a normally closed solenoid valve 958, which can be turned on when the grill 10 is to be turned on and operational. The valve 958 feeds a thermal mass flow meter 960 which enables a flow value to be computed prior to the gas being fed to a gas distribution manifold 962. The manifold 962 provides gas to each of the gas valves 964, with one being provided for each of the pairs of burners 320. The valves 964 may be flow controlled safety valves.

FIG. 7c illustrates an electrical distribution schematic illustrating an electrical distribution terminal 966 that connects to the igniters 968, one for each pair of burners 320, each having spark electrode 970 to provide a spark to ignite the respective burner 320 when gas is flowing to that burner 320. The electrical source 972 connects to a normally open relay 974, which connects to a panel-mounted on/off switch 976. A gas flow valve relay 978 is used to power the gas flow valve solenoid 958 (see FIG. 7b). This ensures that gas will only flow to the burners 320 when the igniters 968 can be fired.

FIG. 7d illustrates a computer-controlled fuel delivery and control system 1000 that may be incorporated into the autonomous cooking grill 10 as shown in FIG. 1c that does not require individual control knobs 220. The system 1000 allows the grill 10 to utilize high flames to quickly warmup the grates 30 while avoiding the need to manually throttle the flame or to manually observe temperatures of the grates 30. A gas inlet can feed into a gas modulating valve 1002 (e.g., natural gas modulating valve). The valve 1002 controls a gas feed line 1004 that delivers the gas to a manifold (not seen in FIG. 7d). The manifold distributes gas to a safety gas valve 1006 for each burner 1010 via a respective burner feed line 1008. It can be appreciated that the gas valves 1006 can be flow controlled or on/off safety-type valves. In this example, a grate temperature sensor 1012 uses an infrared beam 1014 directed at one or more of the grates 30, the grill's control system can monitor and control the grate surface temperature automatically, e.g., by adjusting the modulating valve 1002 to maintain a grate temperature that is within a threshold range of temperatures. It can be appreciated that other temperature sensors 1012 may additionally or alternatively be used, such as a thermocouple. The configuration shown in FIG. 7d provides equal fuel delivery to each burner 1010 (that has been turned on by its valve 1006) to maintain a consistent grate surface temperature for consistent cooking. As such, the temperature of only a single grate 30 is required to perform the monitoring and control. It can be appreciated that the computer-controlled system 1000 also enables the grill 10 to perform automated warm-up operations and to automatically adjust the grate temperature depending on what is being cooked.

FIG. 7e provides a perspective view of the underside of the chassis of the autonomous cooking grill 10. To help control heat within the chassis zone, a double firewall system may be used. The double firewall system includes a pair of wall structures 1020 that provide an additional layer of material between the hot fire box zone 1022 and the relatively colder zone 1024 that contains sensitive mechanisms positioned beneath the upper surface of the chassis. The wall structures 1020 can be spaced from each other to provide an air gap. The air gap could also be filled with an insulating material. The wall structure(s) 1020 can be coated in a high temperature, insulating paint. A flexible insulative wrapping such as Kevlar can also be applied to help inhibit additional heat transfer. By segregating the “hot” and “cold” zones 1022, 1024, fresh air can be blown around the cold section 1024 of the chassis to help prevent stagnant air from heating up. For example, a pair of blowers (not shown) rated for 250 m³/h would enable the system to evacuate all air in the chassis every 2.5 seconds.

FIG. 8a shows a grate system of a cooking grill 10 according to the embodiment shown in FIG. 1a, but which may be adapted to be used in or to utilize features of, the embodiment of FIG. 1b, e.g., as shown in FIG. 5e. The grate 30 in this example is comprised of grate segments 35 which rest on a supporting frame 29 comprised of a frame inner ring 31 and frame outer ring 34 with frame spokes 37 in between. (The frame 29 could also be tubular with corresponding shaping of the grate 30 to securely rest on the frame). The outer edge of each grate segment 35 forms a grate lip 36 which rests over the frame outer ring 34. The frame inner ring 31 is attached to the hub 40. The grate may be comprised of grate segments 35 on a frame 29, since cleaning is easier with grate segments 35, or a one-piece grate or griddle that can still be removable for cleaning. The grate 35 (or griddle 350) and supporting frame 29 could also be contiguous, and still be removably attached to the hub 40 to enable it to be removed for cleaning. FIG. 2a shows the outline of an embodiment of an alternative frame to support the grate 30.

A hub rotating mechanism 39 is comprised of a hub attachment piece 43, an axle 42, and an actuator connector 41. The axle 42 is attached at a first end to the hub attachment piece 43 which is secured under the center of the hub 40. The axle 42 is connected at a second end to the actuator connector 41 which is attached to an actuator (not shown) within the actuator cover 300. It will be understood that movements are affected by a respective actuator and that mechanisms may be driven by available modes such as, pneumatic, hydraulic, belt-driven, leadscrew, ballscrew, etc. For example, there could be two actuators per flipper 62 (one to rotate and one to extend), one actuator for the grill cleaner 72, one actuator for the temperature probe 90, one actuator to rotate the axle 42, three actuators for a flipper ejector (one each to extend, rotate and turn). Other rotational mechanisms such as a harmonic drive may instead be used.

An alternative grate structure is shown in FIGS. 8b, 8c, and 8d, in which each individual grate segment 35 corresponds to an individual cooking surface. That is, while FIG. 8a illustrates a set of three cooking surfaces in each segment 35 any one or more cooking slots or areas designated for each piece of cooked food can comprise a segment 35. FIGS. 8b and 8c illustrate a potential tradeoff between the number of cooking surfaces or slots and the amount of room available in the chassis for heat shielding, thermal management, and liner travel of mechanism. The example shown in FIG. 8b provides fourteen (14) cooking surfaces (segments) 35, while the example shown in FIG. 8c provides twelve (12) cooking surfaces (segments) 35. It can be observed that by reducing the number of segments 35 in this example, additional area is provided around the grate 30 for a given sized chassis. Moreover, having fewer cooking surfaces (segments) 35 requires fewer burners 320, 1020. This will reduce the gas consumption as the overall cavity is smaller and the amount of cast iron used is less. Furthermore, as shown in FIG. 8d, the resulting grate would end up being wider and can thus accommodate patties and other cooked items that are larger in diameter. As such, the geometry and number of cooking surfaces (segments) 35 can be adjusted to tune the grill 10 the specifications required by the particular application or installation allowing for further customization and adaptability to various cooking environments.

FIG. 8e further illustrates configuration considerations that can be made to adapt the size of the grill 10 to accommodate different footprints and existing workspaces into which the grill 10 is integrated. For example, in the lower view in FIG. 8e, a design such as that shown in FIG. 2b having a set of control knobs 220 can enlarge the footprint of the frame 20 by, in this case, up to two inches. As such, removal of the control knobs 220 as shown in FIG. 2c, for instance, can lead to additional design configuration options. In one option, the overall size of the grill 10 can be reduced by having a shorter depth. In another option, using the same footprint, the chassis can be increased in size by the dimension associated with the control knobs 220 to have additional space for the linear travel of the mechanisms and tools described herein. For example, the flipper 62 may be designed with longer fingers to create an enhanced or more precise flipping action. The different configurations are illustrated in FIG. 8e wherein the overall grill depth (G_{d}) can permit a larger chassis depth (C_{d}) within the same footprint, when the control knobs 220 no longer need to be accommodated within that footprint.

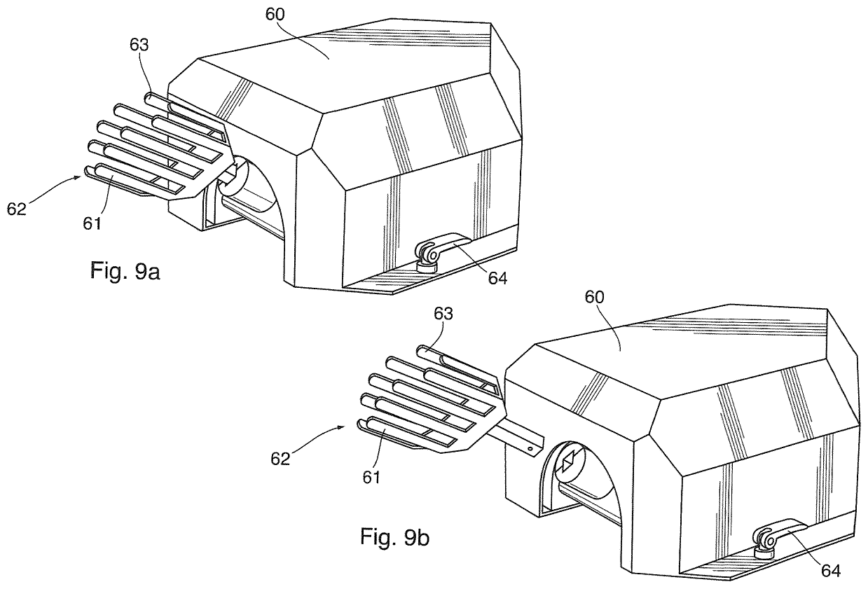

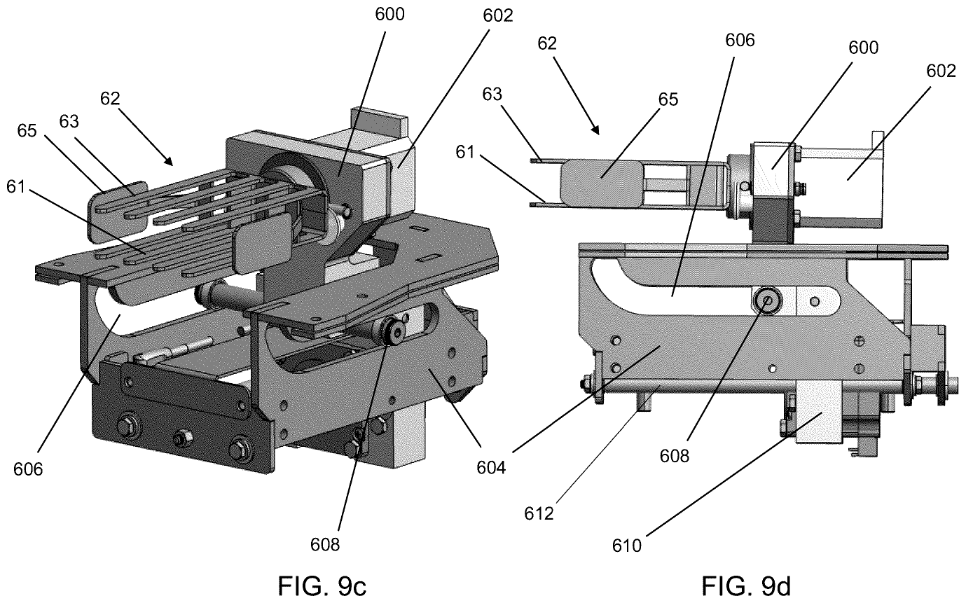

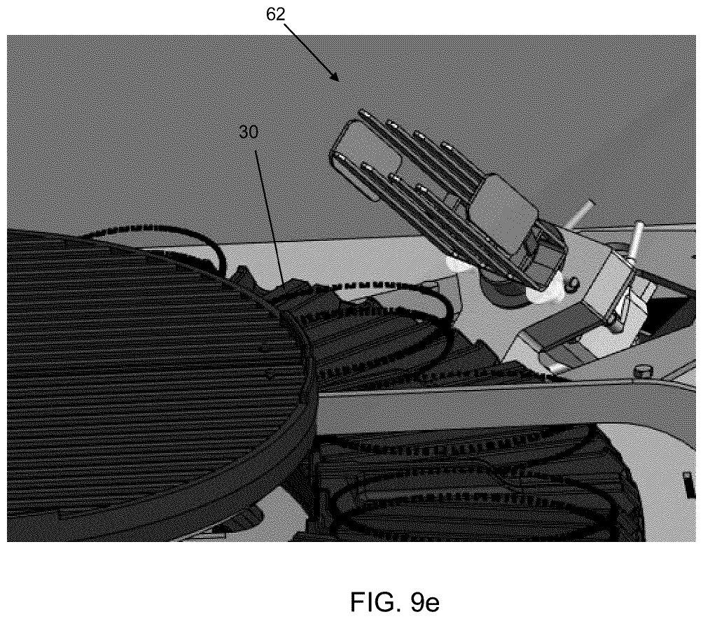

FIGS. 9a and 9b show an autonomous flipper 62 of a cooking grill, which can be adapted for use with the embodiments of FIG. 1a, 1b or in other configurations. In this example, the flipper 62 is covered by a first flipper housing 60, and the second flipper housing 50 can be identical, with the only difference being the placement around the grate 30. The flipping system comprises the first flipper housing 60 which houses the flipper 62. The housing can be removed with the quick release handle 64. In this embodiment such handles 64 are found on each of the first flipper housing 60, second flipper housing 50, grill cleaner housing 70 and temperature probe housing 80. It will be understood that other mechanisms for securing the housings may be used.

When a flipper 62 is activated, it emerges from the flipper housing 50, 60 and the flipper's lower prongs 61 slide just below the top of the grate slats 28 (see FIG. 8) and upper prongs 63 slide in above a food product. The flipper carriage may be attached to a leadscrew which is driven by a motor. When the motor actuates, it turns the leadscrew which pushes the flipper forwards. The leadscrew carriage is attached to a CAM which provides the direction for which the flipper moves as would be understood by those skilled in the art. The flipper 62 is then instructed to raise up to lift the food product held between the upper prongs 63 and lower prongs 61. Another motor may be connected behind the coupling of the flipper attachment and flipping carriage. When the flipper is instructed to turn, this motor may be turned on. Other mechanisms can be used to turn the flipper 62, e.g., magnets. The flipper 62 twirls 180 degrees and lowers the food product back onto the grate slats 28 (reversing the upper and lower prongs to lower and upper prongs), after which the flipper 62 twirls back 180 degrees and retreats back into the housing 50, 60. In this embodiment, the flipper 62 slides out of the housing 50, 50 by a leadscrew powered by an electric actuator and travels on a cam which raises the flipper 62 off the grill and a second actuator rotates the flipper 180 degrees and retracts it back on the cam to a home position. With the embodiment having a griddle 350, the lower prongs 61 slide along the griddle 350. The prongs 61, 63 may also be removable from the flipper 62, e.g., using magnets or other coupling/decoupling mechanisms.

FIGS. 9c, 9d, and 9e illustrate an alternative configuration for a flipper 62. Referring first to FIGS. 9c and 9d, the flipper 62 may include opposing sets of prongs 61, 63, which as discussed above, can be sized and spaced to permit the prongs 61, 63 to be inserted between slats 28 of the grate 30. Also shown in this example are side guards 65 which may be included to encourage insertion of the food product between the sets of prongs 61, 63 to permit a rotational movement to “flip” the food product such that an opposing side is placed on the grate 30. In this example the flipper 62 is coupled to a body 600 via a flipper motor 602. As seen in FIG. 9d, the body 600 also supports a wheeled axle 608 that follows a track 606 as a drive motor 610 moves the body 600 towards and/or away from the grate 30. The drive motor 610 may take the form of a captive nut type motor that spins a nut that interacts with a threaded shaft 612. That is, as the drive motor 610 rotates its internal nut, this cause the motor 610 to follow along the shaft 612 and cause the moveable upper portion of the body 600 to follow the contour of the slot 606 and consequently lift the flipper 62 as shown in FIG. 9e. In this way, the flipper 62 can insert the prongs 61 (or 63) between the slats 28 from beneath and capture the food product between the sets of prongs 61, 63 as it raises through the slats 28 to in turn raise the food product off the grate 30 and minimize damage to the surface of the food product as may occur when scraping the food product off the grate 30. It can be appreciated that the drive screw mechanism shown in FIGS. 9c-9d is only one example with other examples include a belt and pull, articulated arm, telescopic arm with pivotable hinge, etc.

In the embodiment shown in FIG. 1a, ejectors 99 push, pull, or flip food off the grate 30 or griddle 350, and in an embodiment, the ejectors 99 (not shown in the figures) may have the same configuration and action as the flipper 62 described above. In a further embodiment the flipper 62 may also serve as an ejector rather than having a separate ejector (which may necessitate moving the flipper 62 close to the bins.

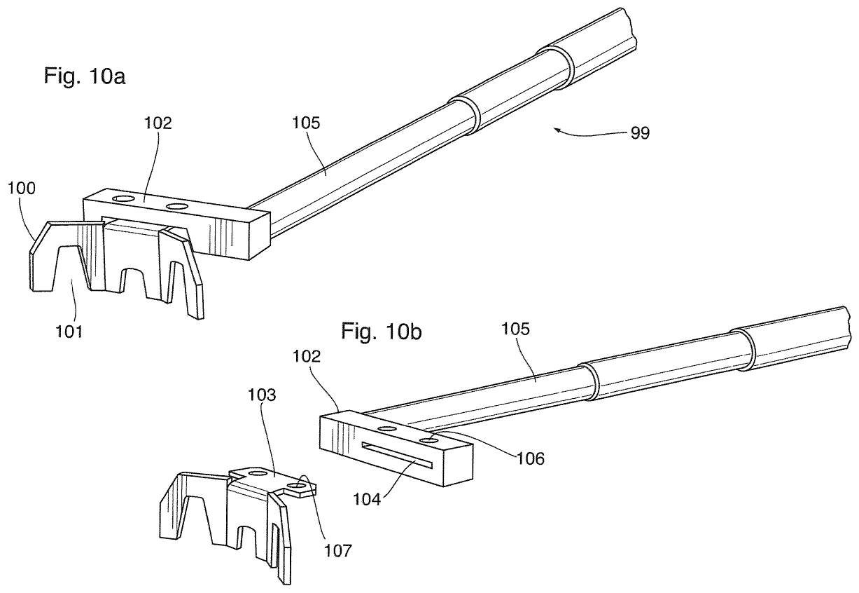

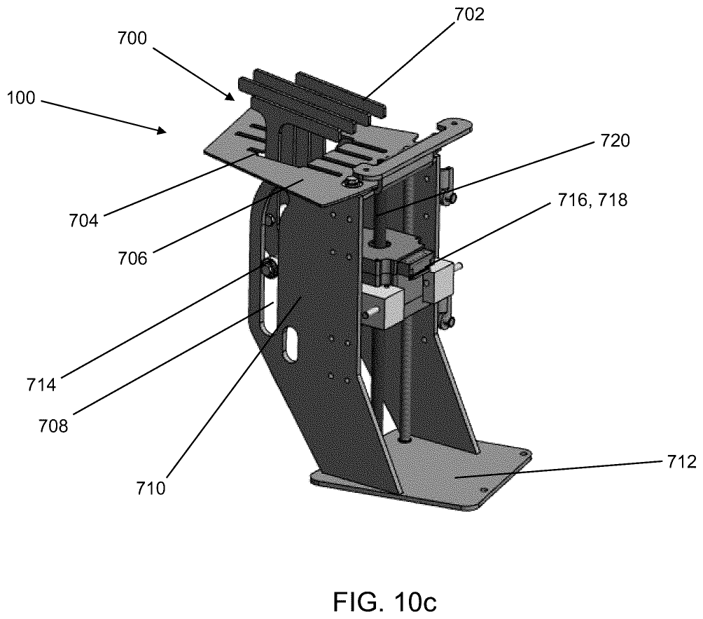

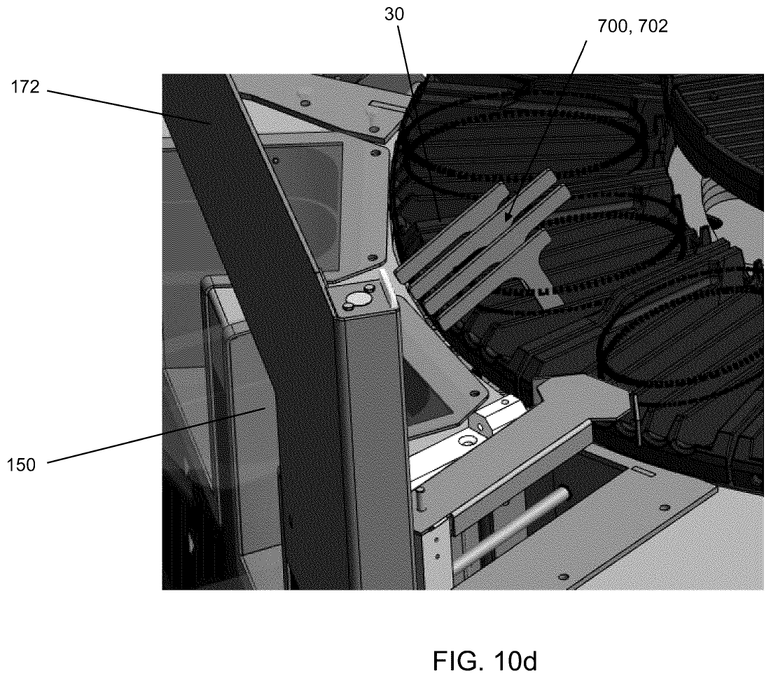

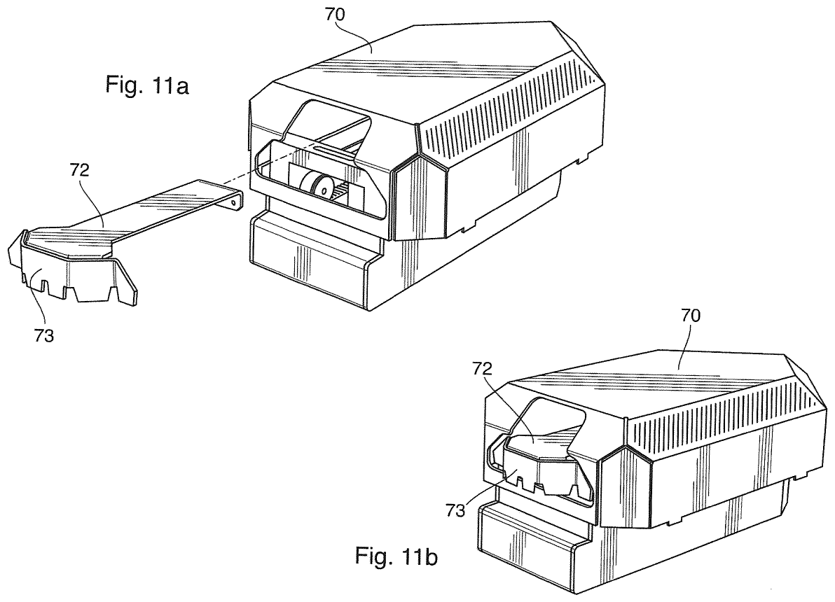

In an embodiment with separate ejectors 99, FIGS. 10a and 10b show an autonomous ejector 99 of a cooking grill, which in this figure is described as having a first ejector face 100, but the ejector with the second ejector face 110 can be identical, and the only difference is the placement around the hub 40, and a different ejector face if desired. The ejector face 100 is extended by the ejector extending arm 105. The ejector extending arm 105 has an ejector arm attachment mechanism 102 with a slot therein to attach an ejector face 100. The ejector face 100, 110 has an ejector face attachment mechanism 103 that fits into the slot 104 in the ejector arm attachment mechanism 102 which is attached to the end of the ejector extending arm 105. The ejector face attachment mechanism 103 can be secured into the slot 104 through fasteners or magnetically (not shown) through the corresponding arm attachment holes 106 and face attachment holes 107. The ejectors 99 are located under the ejector plate 282 (shown in FIGS. 5a to d) and an ejector 99 is on either side of the axle 42 which comes up through the ejector plate opening 283.

When an ejector 99 is activated, the telescoping ejector extending arm 105 extends to push an ejector face 100, 110 against a food product and push the food product off the grate 30 or griddle 350. The ejector face grooves 101 fit over the grate slats 28 to enable the ejector face to scrape a food product off the grate 30. For a griddle 350, the ejector face 100, 110 is raised to scrape the food product off the griddle and the ejector face 100, 110 may be a flat face rather than with ejector face grooves 101. The telescoping action of the ejector 99 is driven by a cable and pulley system underneath the grill powered by an electric actuator. As will be understood the ejectors 99 may be configured differently including not having a telescoping aspect. For example, the ejectors 99 may have a solid shaft that is actuated to extend the ejector faces 100, 110 forward with additional room within the hub to accommodate the additional length.

An alternative ejector system 100 is shown in FIG. 10c, which is adapted for the embodiment shown in FIG. 1b but may also be adapted for use in the embodiment of FIG. 1a by being positioned below the grate 30. In this example, the ejector system 100 includes a set of fingers 702 that are raised through slots 704 in a plate 706 that is positioned below the grate 30 such that the fingers 702 are aligned with the spaces between the slats 28 in the grate 30. The fingers 702 are coupled to a body (not visible), which supports a wheeled axle 714, which follows the contour of a slot 708 to have the fingers 702 emerge vertically then push forward as illustrated in FIG. 10d to lift the food product off the grate 30 and push it towards a bin 140, 150 as also seen in FIG. 10d. The ejector system 100 can use a threaded shaft 720 along which a drive motor 716 having a captive nut travels in operation, similar to the flipper 62 shown in FIGS. 9c-9e. The ejector 700 not only provides a larger surface area for interacting with the food product, by emerging from below, the food product can be lifted off the grate 30 in a more uniform and evenly distributed manner to avoid damaging the grilled surface of the cooked food product. Moreover, placing the ejector system 700 below the grate 30 can save space and/or avoid utilizing space in the hub 40 area, when compared to the embodiment shown in FIG. 1a.

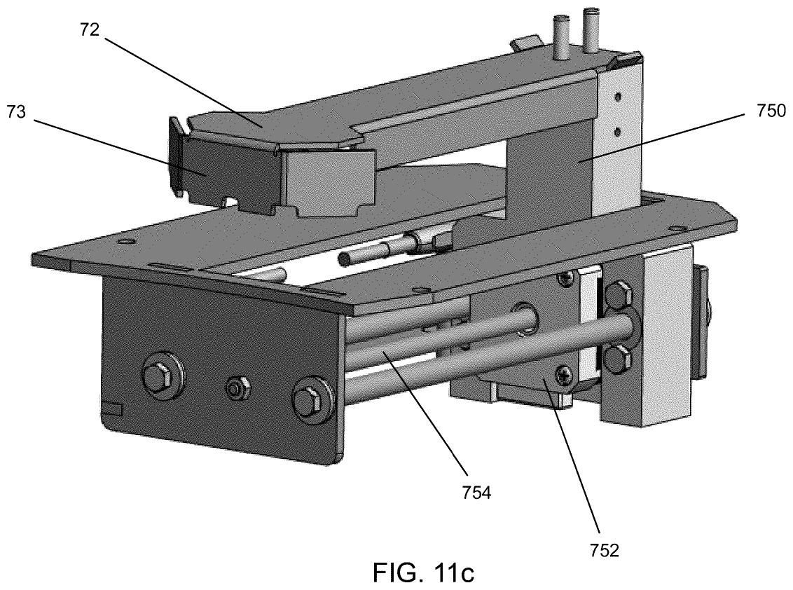

FIGS. 11a and 11b show an autonomous grill cleaner 72 of a cooking grill 10 according to the embodiment shown in FIG. 1a, with a grill cleaner housing 70. The grill cleaner 72 of the autonomous cooking grill cleans the grate slats 28 (or griddle 350) after a food product is ejected from it. For the embodiment of the autonomous cooking grill with a grate 30, the grill cleaner face 73 may have grooves to scrape along the grate slates 28 towards the hub 40 and scrapes back into the grill cleaner housing 70 with any debris falling through the grate 30. The grill cleaner 72 may be powered in this example, by a belt on a slide driven by an electric actuator which pushes the grill cleaner 72 and backward over the grate 30. Alternatively, the scraper can also be driven by a rack-and-pinion leadscrew or pneumatic actuator. In an embodiment with a griddle 350, as shown in FIG. 13, the grill cleaner 72 may have a flat face 73 (not shown) to clean a griddle 350, and food debris may be pushed through an ejector opening 44 across from the grill cleaner housing 70 and through a slot in front of the grill cleaning housing 70 (not shown).

FIG. 11c illustrates another example configuration for the embodiment shown in FIG. 1b. In this example, a similar grill cleaner 72 and face 73 are shown, which permit the slats 28 of the grate 30 to be cleaned. In this example, the grill cleaner 72 is supported by a body 750 that is driven along a threaded shaft 754 using a captive nut style drive motor 752 to provide precise control and reliability as with some of the other tool features 22 described above. It can be appreciated that the configuration shown in FIG. 11c may also be adapted for use with the embodiment shown in FIG. 1a and need not be limited to any particular configuration.

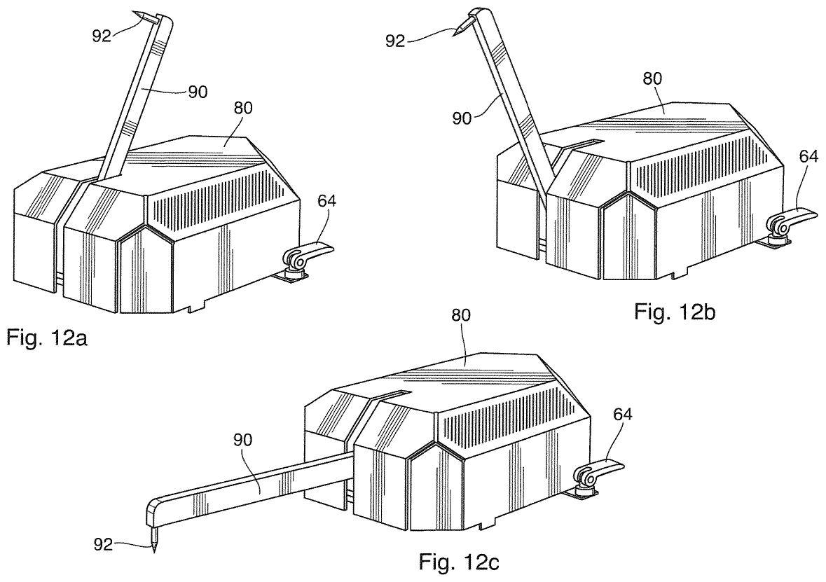

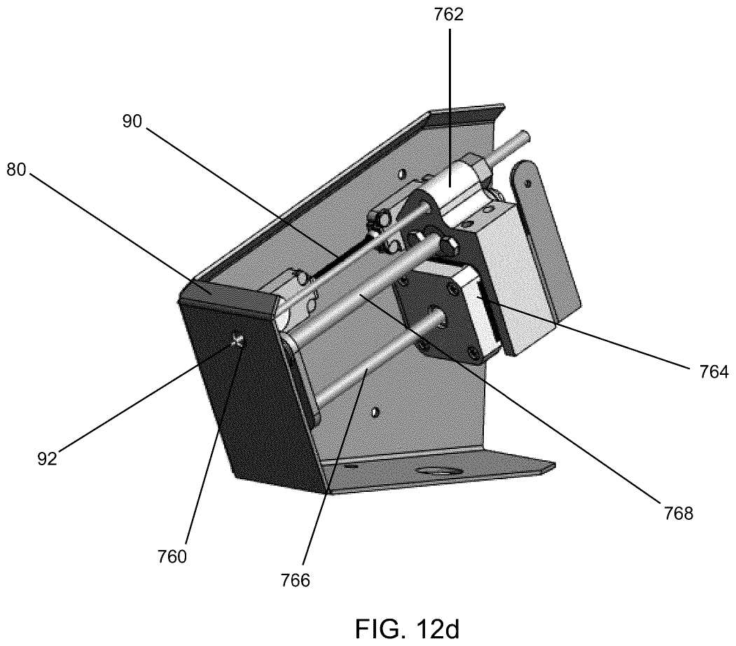

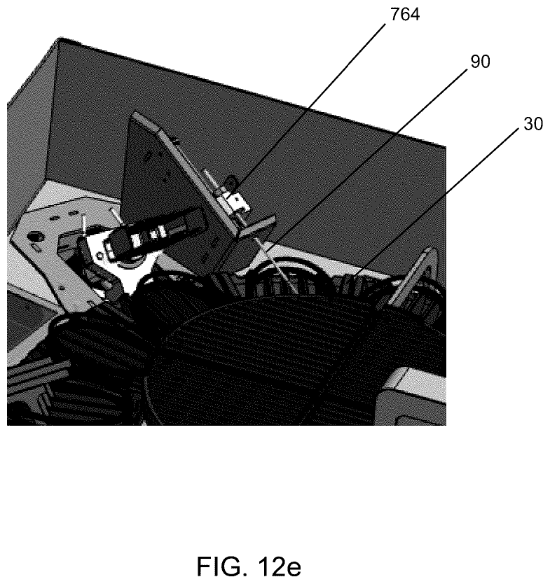

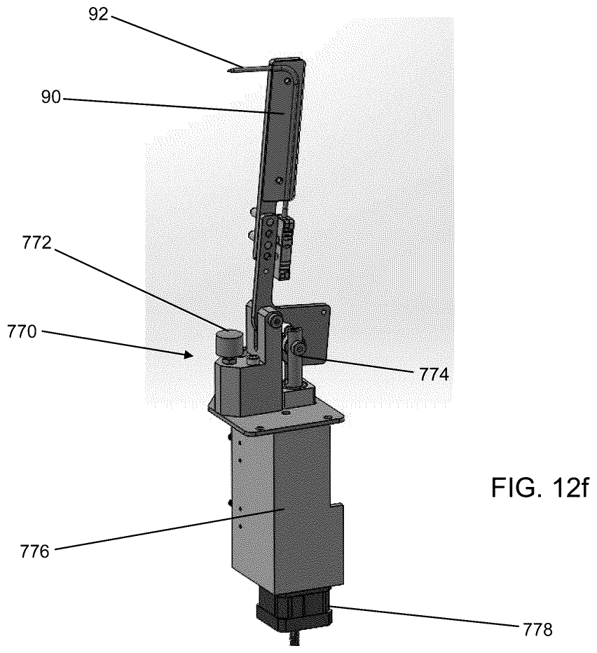

FIGS. 12a to 12c show an autonomous temperature probe arm 90 of a cooking grill 10 as shown in FIG. 1a, having a thermometer 92 and with a temperature probe housing 80. FIG. 12a shows the temperature probe arm 90 in sanitizing position where the thermometer 92 and temperature probe arm 90 can be manually wiped clean with sanitizer; FIG. 12b shows the temperature probe arm 90 in home position; and FIG. 12c shows the temperature probe arm 90 in a probing position. In this embodiment, the temperature feature is activated for food products requiring certain temperatures to be reached for safety (thus, not veggie patties), but may also be used for quality control to ensure desired temperatures are reached, either for safety or food order reasons (e.g., to achieve certain “doneness” levels, such as to detect a medium rare versus medium doneness). When activated to obtain a temperature reading when food product is present, the temperature probe arm 90 pivots on an axle driven by a belt and electric actuator which lowers the thermometer 92 into the food for a specific amount of time and then retracts the temperature probe arm 90 to a home position. The motor spins in one direction to move the temperature probe arm 90 downwards and spins in the opposite direction to move the temperature probe arm 90 upwards. The temperature probe arm 90 and thermometer 92 typically require sanitizing after multiple uses in accordance with safety protocols. This can be programmed to occur automatically after a certain time period or the temperature probe maintenance button 264 may be pushed manually. When sanitizing position is activated, the temperature probe goes back into sanitizing position. The temperature probe arm 90 and thermometer 92 can be sanitized manually, typically with a food grade sanitizing wipe. Sanitizing may also be performed by holding the thermometer 92 over a flame to reach a temperature suitable for sanitation. It will be understood that a sanitizing position is not required but is helpful to avoid sanitizing preparation from dripping onto the grate 30. It will be understood that sanitizing could be automated as well (e.g., by holding the thermometer 92 over the grate 30 when an open flame is present.

FIGS. 12d and 12e illustrate another example of a configuration for a temperature probe arm 90, which advances towards and retreats from the food product rather than pivot into a temperature reading position in the embodiment shown in FIGS. 12a-12c. In this example, the probe arm 90 is supported within a locking collar 762 which permits the probe to be adjustable according to the thickness of the food product being measured. The probe arm 90 may include a tip 92, which includes a thermometer or other temperature sensing mechanism to measure the temperature of the food product into which it is inserted. The collar 762 is coupled to a drive motor 764 which, as described above, may include a captive nut for advancing the motor 764 along a threaded shaft 766 or drive screw. The body of the motor 764 can also slide along a parallel guide shaft 768 to inhibit rotation of the motor 764 itself. As shown in FIG. 12e, the cover 80 can be secured adjacent to the grate 30 with the probe arm 90 directed at a station at which the temperature is measured by activating the motor 764 to advance the probe arm 90 towards the food product. It can be appreciated that the probe arm 90 configuration shown in FIGS. 12d-12e can also be adapted for use with the embodiment shown in FIG. 1a.

FIG. 12f illustrates yet another example configuration for the temperature probe arm 90. In this configuration, the tip 92 protrudes perpendicularly from the end of the probe arm 92 and the probe arm 92 is operated by a rotary mechanism 770. The rotary mechanism 770 includes the probe arm 90 rotatably connected to a piston-driven actuator 774 and may include a height adjusting stopper 772 to control the height of the tip 92 when the probe arm 90 has been rotatably deployed. The rotary mechanism 770 is controlled by a motor 778 contained in a housing 776, with the housing 776 secured below the upper surface of the chassis of the grill 10 similar to that shown in, for example, FIG. 6a. By actuating the rotary mechanism 770, the probe arm 90 rotates downwardly towards the grates 35 to engage the tip 92 with the food being cooked. The probe arm 90 and/or tip 92 may be removable to permit ease of cleaning.

It will be understood that the housings described above aid in protecting the mechanisms for the flippers 62, temperature probe arm 90 and grill cleaner 72, but are not required.

The autonomous cooking grill 10 can grill any food, however, the autonomous features of the cooking grill shown in the figures work with suitable food products that are capable of being flipped by the flippers 62 and ejected by the ejector when being cooked on the grate 30. If a central grate or griddle is located at the hub 40, other food can be cooked at the same time, independent of the autonomous cooking sequences. Moreover, certain stations can be used selectively, e.g., if only rotation and temperature measurement are required. Examples of such suitable food products are, burgers (meat and veggie), steaks, fish, chicken, sausages, samosas, Jamaican patties, bagels, ham slices, dumplings, waffles, breakfast sandwiches and other foods preferably with a consistency and/or shape that does not fall through the grate or fall apart when flipped. When using a griddle 350, there may be more food options. Moreover, by using the emergency stop button (or any manual mode (e.g., via a touchscreen button), either during a tool failure or as desired, the grate 30 can be used as a traditional stationary grill. That is, a manual mode may be provided where the grate 30 is stationary or just continues to rotate without any automation. In such a mode, the tools may be retracted out of the way of the grate 30 to permit manual usage without interfering.

It will be understood that the autonomous cooking grill can be used to grill any foods without activating the features which provide autonomous flipping and/or ejecting and/or temperature measurement. The autonomous grill cleaner 72 can also not be activated if desired.

When the autonomous cooking grill 10 is loaded with a suitable food product, an autonomous flipper 62 flips the food product, and an autonomous ejector system ejects the food product from the grate 30. The autonomous cooking grill can also comprise an autonomous grill cleaner 72 to clean a segment of the grate 30, and additionally comprise an autonomous temperature probe system to measure food product temperature. Combining all these features, embodiments shown in the figures (e.g., as shown in FIGS. 1a and 1b) provide an autonomous cooking grill 10 which flips a food product, delivers a consistently safely cooked food product, delivers a food product with grill marks on both sides, provides quality control checks of food product temperature for safety, removes a food product when cooking is complete, and cleans the grill for the next food product.

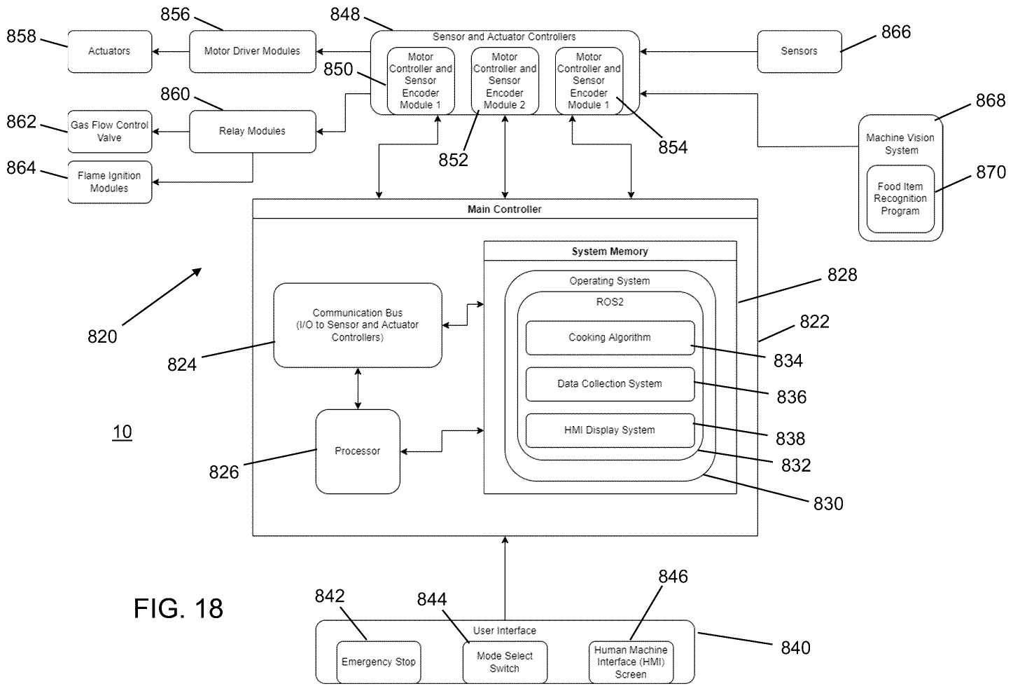

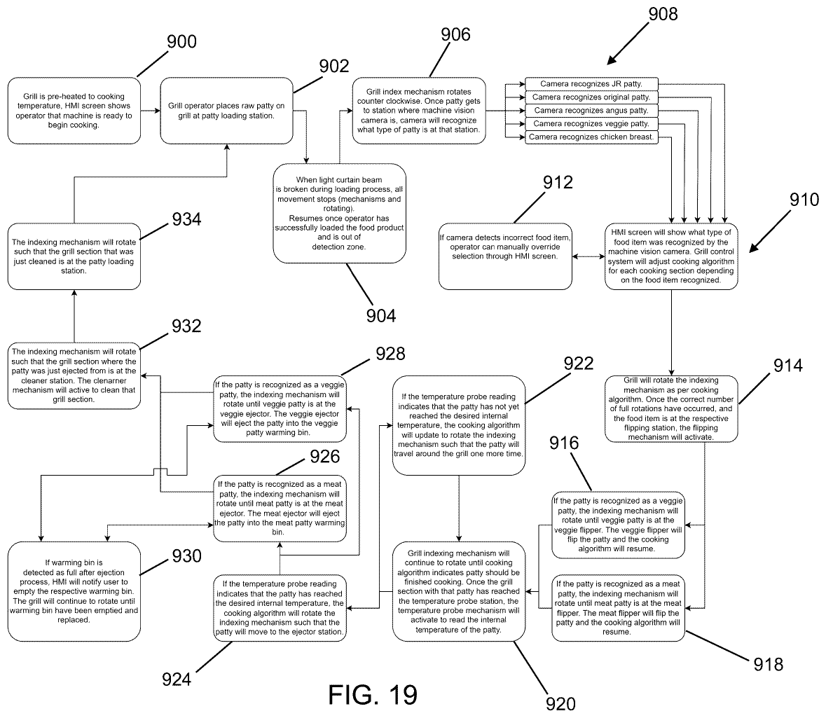

In operation of the embodiment of the autonomous cooking grill 10 shown in the figures, and in particular FIG. 3, gas flow can be delivered to the gas burners 320 individually by turning open the gas knobs 222, 224, 226, 228, 232, 234. Alternatively, a user can manually light one or more of the burners and/or other electronic and automated ignition systems could be implemented. The temperature of the grate 30 may be displayed on the main user display 262 in some embodiments, which may also display the temperature of the thermometer 92 (FIG. 12a) on the temperature probe 90, and any notifications, alarms, and any safety protocol (such as, Hazard Analysis Critical Control Point, known as “HACCP”) logging information. All this information as well as the controls can be adapted as required and information can appear in this confirmation or remotely and can be controlled by one or more computing devices which may include a touch screen or remote control rather than knobs. A control system having a computer with a processing unit may be programmed to manage the particular foods being cooked on the autonomous cooking grill and the various components of the grill. An example of such a control system 820 is shown in FIG. 18 and described further below. It can be appreciated that in the event of a vision system failure or other autonomous failure, the display screen may provide a UI option to select the type of food product being added to the grate 30 at any given time. Moreover, such UI options can provide an option to manually move portions of the tools (e.g., flipper 62) to permit cleaning, maintenance, etc.

The processing unit may be configured to turn the grate 30 or griddle 350, activate the flipper(s) 62 to flip any food, activate the temperature probe arm 90 to check the temperature, activate the grill cleaner 72, and adjust the gas flow.

Grilling is typically started once the grate 30 or griddle 350 is hot enough and an infrared sensor may be used to determine the temperature of the grate/griddle. An actuator (not shown) is electrically turned on by pushing one of the selection buttons 266, 268, 272, 274, 276 and the autonomous cooking grill can be left plugged in (cord and plug not shown). Alternatively, placement of patties or food on the grate or griddle may be sensed with visual or load sensors to automatically start the grate/griddle turning. The actuator turns the axle 42 which is connected to the bottom of the hub attachment mechanism 43, which hub attachment mechanism 43 is attached at its top to the hub 40. Since the hub is above the ejector plate 282, an ejector plate opening 283 allows the axle to connect to the bottom of the hub attachment mechanism 43. The turning of the hub 40 above the ejector plate 282 causes the grate 30 to rotate counterclockwise.

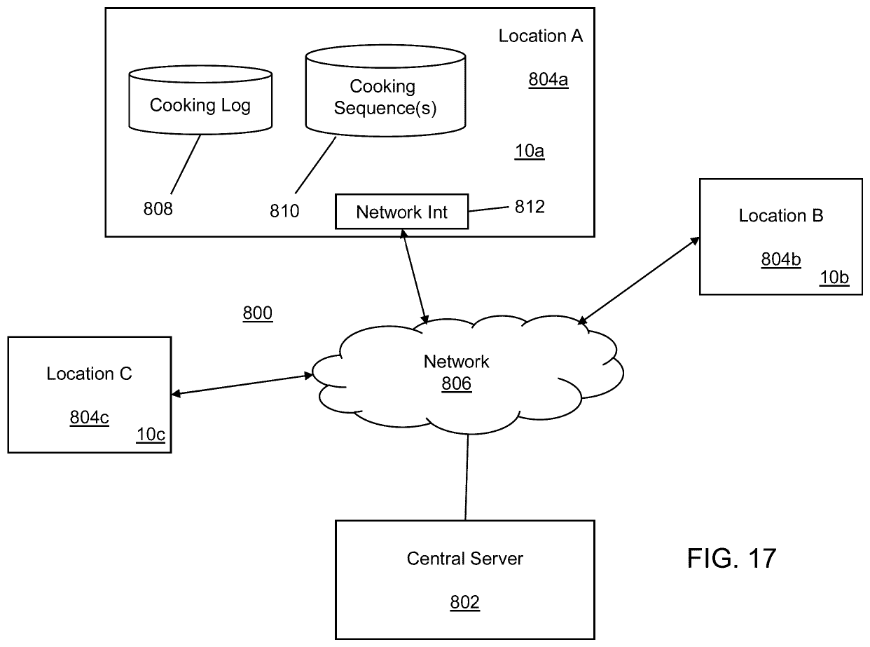

The autonomous cooking grill 10 can be programmed so that the grate 30 stops twelve, fourteen or any other desired number of times in a rotation. For example, in another embodiment the autonomous cooking grill has fourteen slots rather than twelve. Alternate programming (e.g., using different cooking sequences 810—see FIG. 17 described below) sets stops only at stations (e.g. flipping, temperature and cleaning) depending on the type and/or amount of food product on the grill. That is, the grate 30 could dwell at certain locations until it needs to be indexed to the next station. For example, a patty could be cooked in place until it needs to be flipped at which time the cooking algorithm indexes the grate 30 such that the patty is aligned with the flipper 62. As such, various turning sequence logic can be used. When used, selection buttons can be set for cooking various food products, for example, the settings can be for grilling various patties, such as a large beef patty, regular beef patty, veggie patty, junior beef patty and slider (small beef) patty, respectively. In this embodiment the selection button lights up to indicate what selection is active to confirm the selected setting. To cook a different patty, the vision system 263 can detect the different type or a corresponding selection button may be pressed to activate a cooking protocol for that next new patty (e.g., to override the UI). As such, a large beef patty could have one selection and the next selection could be for a veggie patty etc.

The autonomous cooking grill stops at positions as the grate 30 or griddle 350 rotates. Using the individual grates segments 35 as positions, the grate may stop at each turn to move to the next grate segment's position, or only at specific positions e.g. when requiring either the flipping, cleaning, temperature probe, and/or ejecting activities. In an embodiment, the grill cleaner housing 70 is the twelfth position, and moving counterclockwise the next position is the first position which is where each patty is first placed/loaded on the grate 30 or griddle 350. Sensors (e.g. weight or camera/visual—see FIG. 2e) can be used to detect that a patty is presently loaded on the grate 30 or griddle to automatically start the rotation and to automatically activate the appropriate actions (flipping, temperature probing, ejecting and cleaning).

If a veggie patty selection button is chosen, when the veggie patty reaches the first flipper housing 60, the flipper 62 flips the patty during that stop, and the veggie patty moves onwards. When the veggie patty has rotated around on the grate 30 enough times to be cooked, the first ejector is activated when the patty is next to that stop and the ejector face 100 pushes the patty onto the first ejector ramp 120 and into the first bin 140. If there is another veggie patty on the grill, it will go through the same stops and processes. The activation of an ejector also activates the grill cleaner 72 to emerge from the grill cleaner housing 70 and scrape the grill for the next patty or food product.

If a regular beef patty selection button is chosen, when the regular beef patty reaches the second flipper housing 50, the flipper 62 flips the patty during that stop, then the patty moves onwards. In the embodiment in which there is a temperature probe, at the temperature probe housing 80 the grate 30 stops and the temperature probe is activated to probing position in which the thermometer 90 is inserted in the patty and then moves back to idle position. All temperatures of patties or food on the grate/griddle can be logged per HACCP logging protocols. When the burger has rotated around on the grate 30 enough times to be cooked (e.g., a further rotation can be applied if a desired temperature is not yet reached), the second ejector is activated so that the second ejector face 110 pushes the patty onto the second ejector ramp 130 and into the second bin 150. In accordance with HACCP principals, the temperature probe maintenance button 264 lights up and auditory alarm sounds to indicate that the thermometer 92 needs to be manually sanitized or may be held over a flame to heat it up enough to meet required sanitation standards. It will be understood that in other alternative embodiments the grate/griddle could turn clockwise, there could be more or less stops, the grate could be larger or smaller, there could be only one flipper and one ejector or multiple flippers and ejectors, there could be various speeds of rotation, or one gas knob or an on/off switch to control all burners. Further, the grate or griddle could turn counterclockwise and clockwise and with the logic of artificial intelligence could take the optimal path e.g. if the food has reached optimal cooking and is farther from an ejector if it continues to travel in the direction it is moving, the direction could change to reach ejection faster.

Using different ejectors and ramps and bins avoids possible cross contamination and addressed some consumer preferences for their food product not to come into contact with another food product.

The patties or other food product remain warm in the bins 140, 150 given the vicinity to the heat from the grill. Further, the bins can be made of insulated material to assist in keeping the cooked food warm. Alternatively, the food product can be placed in a zone having an electric heater, such as in a warming station or in a bin having an electric heater.

It will be understood that the autonomous cooking grill may be programmed as is advantageous for the particular use and user. Visual and load sensors may be customized to the desired use for the autonomous cooking grill, to sense such actions as whether there is a meat or veggie burger present, when to flip, take temperature, eject, clean etc.

If two different patties are being cooked, for example a regular meat patty and then a veggie patty, the selection button for a meat patty is chosen and it is placed at position 1, and, when the meat patty is at position 2, the selection button for a veggie patty is selected and the veggie patty is place at position 1. The meat patty will be flipped at the second housing 50 whereas the veggie patty will be flipped at first housing 60, each time that the grate 30 makes a rotation. A flipper 62 is only activated to flip the correct patty based on the selection button since the selection button indicates that the patty will be at that spot in six stops for a meat patty and three stops for a veggie patty. The flippers 62 don't flip based on the presence of a burger when the selection button is chosen. In an alternative embodiment the flipper flips based on the presence of a patty sensed with a load cell and/or vision system.

The time for which a food product rotates on the grate 30 is based on the selection chosen, which can be activated by a button as shown, or by a remote control or App or computer program etc. For example, in one setting a junior beef patty rotates twice at 45 seconds each rotation for a total of 90 seconds; a regular beef patty and a veggie patty each do four rotations for a total cook time of about 180 seconds. A larger beef patty may need six rotations for a total of 270 seconds. It will be understood that a larger grate 30 would cook patties in less rotations and increasing or decreasing the heat will also increase or decrease the speed of cooking.

In an alternative embodiment a load cell and visual sensor detects the type of food product and automatically selects the number of rotations, where the food product will be flipped, and when ejected, rather than pressing a selection button.

In an embodiment, as food products are added to the bins, the respective first and second ejector counters 242, 244 keep track with visual or weight sensors, and when at capacity, for example, ten patties, an auditory alarm warning indicates that the bin needs to be emptied. The bin 140 or bin 150 is then emptied and the respective ejector reset button 246, 248 is pushed to reset. If either bin is removed, the grate 30 stops turning, so the ejectors don't push a food product off without a bin present to catch it. Replacing a bin re-starts the grate turning.

Drippings, food debris, grease etc. fall through the grate 30 (or the ejector opening 44 and holes in the griddle 350) and are caught by first drip tray 284 and second drip tray 286. To clean the first drip tray 284, the first drip tray handle 200 is pulled and the first drip tray 284 slides out through the first drip tray slot 205. To clean the second drip tray 286, the second drip tray handle 210 is pulled and the second drip tray 286 slides out through the second drip tray slot 215.

The housings, namely the first flipper housing 60, second flipper housing 50, grill cleaner housing 70 and temperature probe housing 80 are not required, but keep the grill cleaner 72, flippers 62, their inner workings, and the temperature probe inner workings cleaner. The respective housings 50, 60, 70, 80 can be secured with quick release handles 64 so that when cleaning is required, they can be easily removed and reattached, or can have other ways of securing to the grill or not be used at all or be configured as one contiguous housing for the flippers 62, grill cleaner 72 and temperature probe 90.

The grill can be constructed of materials for traditional grills or new materials as developed. For example, the grill body can be stainless streel, and more particularly can be 10-gauge 304 stainless steel. The burners can be natural gas burners that are propane compatible. There can be twelve individual burners for each grill slot in six pairs. Safety measures can be included, for example, if gas knobs are on without flame, the gas valve will automatically shut off. Also, in the absence of electricity, a gas valve will be turned off automatically (although there may be an option to manually turn on). The grate 30 can be high-quality cast-iron or suitable food grade steel, or other material such as a ceramic, and each portion of the grill on which a burger is placed may have parallel lines so all grill marks on patties will be parallel or whatever aesthetically pleasing grill marking is desired. The frame 29 for the grate 30 can be steel.

The flippers 62, grill cleaner 72, ejector faces 100, 110, bins 140, 150 and housings, may all be easily removable for frequent washing. The grate segments 35 are also easily removable for washing but require it less frequently.

In an electric alternative, the gas burners, gas knobs, gas piping etc. are not present and would instead include corresponding electrical connections to electric heat sources. In a further alternative, debris and drippings can be caught through holes in the griddle 350, for example, one per each section that holds a food product, and as such can be configured not to require the large drip trays 284, 286.

In the embodiment shown in FIG. 1a, there are two flippers 62, two ejectors 99, one temperature probe 90 and one grill cleaner 72, however, it will be understood that the grill can be scaled up or down and have single or multiple flippers etc. This embodiment may have a grate 30 or griddle 350. It is to be understood that is the embodiments described herein are not limited to particular variations since various changes or modifications may be made and equivalents may be substituted without departing from the scope of the claims appended hereto. As will be apparent to those of skill in the art upon reading this disclosure, each of the individual embodiments described and illustrated herein has discrete components and features which may be readily separated from or combined with the features of any of the other several embodiments. In addition, many modifications may be made to adapt a particular situation, material, composition of matter, process, process act(s) or step(s) to the objective(s), spirit or scope of the embodiments described herein. All such modifications are intended to be within the scope of the claims made herein.

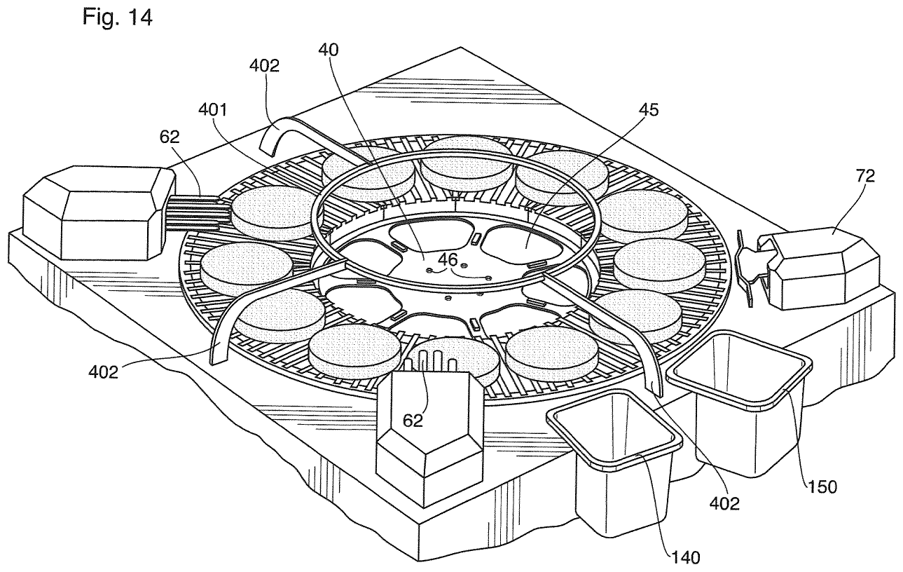

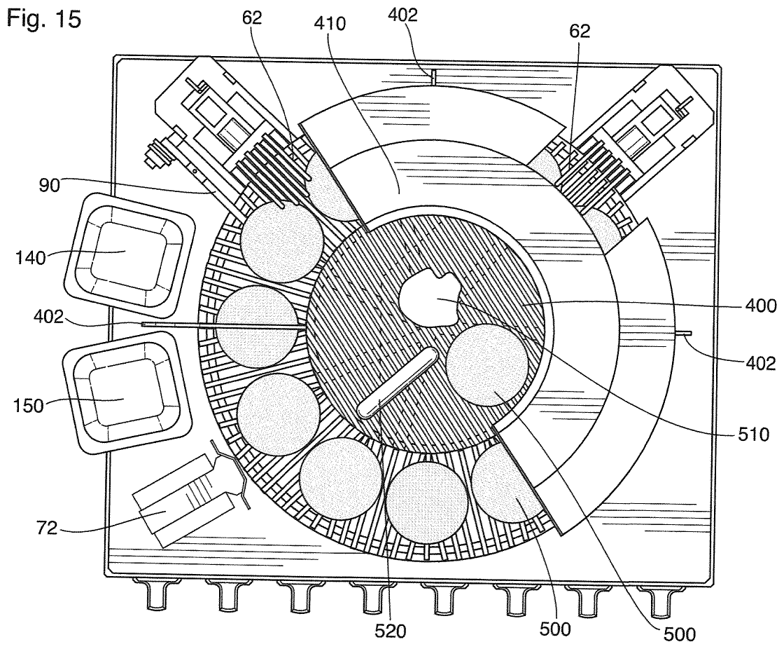

The autonomous cooking grill 10 shown in FIGS. 14 and 15 additionally comprises a non-rotatable center grill 400, shown in FIG. 15, which may be a grate or griddle for manually cooking food, such as a burger 500, chicken 510 and/or wiener 520. FIG. 14 shows a hub 40 with hub openings 45 which allow heat to rise up through from additional gas burner(s) (not shown), for example, four central gas burners or one big gas burner. The autonomous cooking grill 10 with a center grill 400 does not comprise ejectors 99 and as such the hub 40 is lower than the hub 40 shown in FIGS. 1a, 2a, 3, 4, 5a-5d, and 6a. The center grill 400 or the whole autonomous cooking grill 10 of this embodiment may alternatively be heated with electric power. The center grill 400 rests on a grill ring 401, which grill ring 401 is held above the hub 40 by ring supports 402. It will be understood that the center grill could be rotatable, for example, if it was instead connected to the hub by a central support (not shown). A center grill 400 may also be used with the embodiment shown in FIG. 1b and related figures described above in any configuration having one or more tool features 22.

FIG. 15 has some modifications from the autonomous cooking grill of FIG. 14 namely the addition of a cover 410 and the removal of housings for the flippers 62. The autonomous cooking grill 10 shown in FIGS. 1a, 2a, 3, 4, 5a-5d, and 6a may also comprise such a cover 410. The cover 410 partially covers a grill 30 or griddle 350 and decreases cooking time since it traps heat, and it also prevents grease from splattering. It may be removable and can be comprised of sheet metal. In FIG. 15 a temperature probe 90 is located beside a flipper 62.

In a further embodiment, the autonomous cooking grill 10 comprising a grate 30 or griddle 350 connected to a rotatable hub which is connected to a hub rotating mechanism, all supported by a grill body, wherein when the hub rotating mechanism is activated the hub rotates the grate, additionally comprises a robot or a robot arm capable of performing one or more of the functions of food flipping, food ejecting, food removing, food temperature measuring and grate or griddle cleaning. In this embodiment with a robot arm, the robot arm may be situated beside, above or as part of the autonomous cooking grill 10. These robot arms are available from third parties and provide four degrees of freedom or up to seven axes. Where regulations require it, these industrial robotic arms are available in food-grade or covered with a sleeve or similar material to ensure compliance with such regulations, including a sleeve that is pressurized with clean, dry air to limit contamination.

In a further embodiment, the autonomous cooking grill 10 comprises a grate 30 or griddle 350 connected to a rotatable hub which is connected to a hub rotating mechanism, all supported by a grill body, and comprises one or more flippers 62, and comprises a robot arm capable of performing one or more of the functions of food ejecting, food removing, food temperature measuring and grate or griddle cleaning. Alternatively, this autonomous cooking grill 10 may additionally comprise a grill cleaner 72 and/or temperature probe 90, and the robot arm performs at least the functions of food ejecting or food removing.

If there is no power to rotate the autonomous cooking grill 10, it may be used to cook on manually just like a regular grate or griddle, provided that the gas is still working. Moreover, the operator may be given an option to not use automation, in which case an indexing grill can continue to move without any need to stop at particular tools during a cooking sequence. To that end, the autonomous cooking grill 10 may be implementing using an indexing grate 30 as described in any one of the configuration described herein without necessarily any tools positioned about the grate 30. That is, the indexing grate 30 may itself provide the primary functionality of the cooking grill 10 in at least one embodiment.

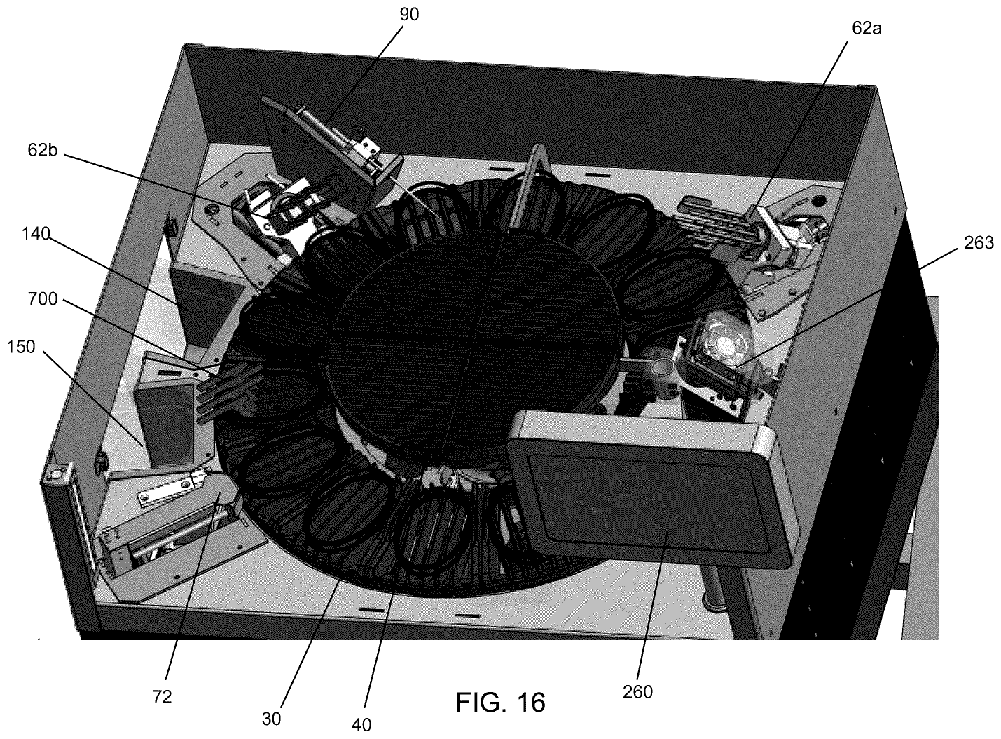

FIG. 16 illustrates an aerial view of the embodiment shown in FIG. 1b to illustrate one configuration that includes an imaging system 263, a first flipper 62, a temperature probe arm 90, followed by a second flipper 62b, followed by a pair of ejector systems 700 (only one shown in alignment with bin 150), and a scraper 72. It can be appreciated that the positioning and spacing of the tool features 22 can be made according to the expected food product and can utilize different index timing accordingly. For example, the grate 30 may turn more slowly or use multiple revolutions depending on the thickness of a burger or steak being cooked. Moreover, the indexing may occur in both directions and need not follow the same direction. For example, when cooking a food product that is flipped twice, a single flipper 62 could be used wherein after a first flip, the temperature is taken, further cooking occurs, then the grate 30 reverses to be flipped again and the temperature taken again before moving to the ejector station.

Referring now to FIG. 17, a cloud-based connected system 800 is shown for connecting and controlling multiple locations 804 (e.g., restaurants) to a central server 802 via one or more networks 806. In this example, three locations (Location A 804a, Location B 804b, and Location C 804c) are shown for illustrative purposes with various features omitted for ease of illustration. At each location, at least one grill 10 is utilized, in this example 10a, 10b, and 10c. Each location 804 stores, either on the grill 10 or in a connected computer network or off-machine computer storage, a datastore 808 for cooking logs, and a datastore 810 for cooking sequences. The cooking logs 808 can be used to track the cook times, temperature readings, inventory counts, etc.

In a commercial kitchen, existing systems such as inventory, equipment networks, and point of sale (POS) can integrate with the autonomous cooking grill 10 to further automate the commercial kitchen environment. For example, as a food product is obtained from storage, it may be tracked through an inventory system, then a restaurant order system, through to addition to the grate 30 and through the autonomous cooking grill 10, to a server's ticket, added to a bill or account, then updates sent through the wider network. Each event can be logged and tracked and used to trigger further operations such as ordering new inventory, updating the bill, issuing a final bill or invoice, etc. The data collected during these operations can further be analyzed to forecast future demand and to improve kitchen workflow procedures. Moreover, order data can be fed to the autonomous cooking grill 10 in real-time to adjust cooking times, “doneness” and other attributes based on what the server enters into the order system. For example, a table that order three striploin steaks may have three different cook types (e.g., one being well done, one being medium rare and the other being medium). Then, as the operator places the food product on the grate 30, the control system 820 can determine that the first one should be associated with the longest cook time, for example. The system can also use historical ordering data to create a detailed cooking schedule and list of when to cook to minimize hold time—or, it can put food directly into a warming bin. It can also recommend when to slack patties at the end of the day. Moreover, the connectivity shown herein can allow the grill 10 to remotely monitored and diagnosed to provide operational and maintenance feedback to the main control system 820.

The cooking sequences 810 can be used to enable an autonomous grill 10 to utilize centrally controlled programming logic that can be updated and revised based on information gathered by the central sever 802 through cooking logs 808 generated at different locations 804, e.g., using a machine learning or other analytics system (not shown).

As indicated above, the autonomous grill 10 includes a control system 820 to enable the various features thereof to be utilized and to operate the tool features 22 autonomously. FIG. 18 illustrates an example of a control system 820 that may be incorporated into the grill 10. In this example, the control system 820 includes a main controller 822 that has a system memory 828 and communication bus 824, which provides inputs/outputs (I/O) to the sensors and actuator controllers. The main controller 822 also includes a processor. The system memory 828 stores an operating system 830, which in this example implements a robotic operating system (ROS) 832. The ROS 832 includes a cooking algorithm 834, which in this example is an implementation of the cooking sequences 810 shown in FIG. 17; a data collection system 836, e.g., to create cooking logs 808, and a human-machine interface (HMI) display system 838, e.g., to provide a user interface to the screen 260 described above. The main controller 822 can communicate with a user interface 840, which includes an emergency stop 842 (e.g., override button), a mode select switch 844 (e.g., to select a cooking mode, whether through a UI or other button/switch/input mechanism), and an HMI screen, e.g., a UI to be displayed on the screen 260.

The main controller 822 also communicates with sensor and actuator controllers 848. This may include a first motor controller and sensor encoder module 850, a second motor controller and sensor encoder module 852, and a third motor controller and sensor encoder module 854. Sensors 866 can provide inputs to the sensor and actuator controllers 848 as well as any machine vision system 868 such as the imaging system 263 described above. The machine vision system 868 can include a food item recognition program 870 to enable detection of the food product that is placed on the grate at any given time.

The sensor and actuator controllers 848 control actuators 858 via motor driver modules 856 and control gas flow control valves 862 and flame ignition modules 864 in a gas implementation via relay modules 860.

Referring now to FIG. 19, operations that may be performed by the control system 820 are shown. At block 900 the grill 10 can be preheated to a desired cooking temperature. The screen 260 can show the operator when the machine is ready to begin cooking. At block 902, the grill operator places a raw (or otherwise to-be-cooked or heated) food product such as a hamburger patty on the grill at the loading station, e.g., at the front of the grate 30 as seen in FIG. 1b. At block 904, as the light curtain beam 14 is broken during the loading process, any movements are halted and the movements resume once the operator has successfully loaded the food product and is out of the detection zone. At block 906, the grill's index mechanism rotates (in the example shown in FIG. 1b) counter clockwise and as the food product enters the field of view 265 of the imaging system 263, the imaging system 263 determines the type of food product at that station, i.e., has just been loaded.

At block 908, in this example, one of multiple detection options is selected, for example, a junior patty, an original patty, an angus patty, a veggie patty, or a chicken breast/chicken burger, each having their own cooking sequence 810. At block 910, the screen 160 can be updated to show what type of food product was recognized by the imaging system 263. The grill control system 820 then adjusts the cooking algorithm 834 (or selects the corresponding cooking sequence 810) depending on what is recognized in blocks 906 and 908. At block 912, if the imaging system 263 detects an incorrect food item, the operator can manually override the selection through the UI presented on the screen 160.

At block 914, the grill 10 rotates the indexing mechanism as per the cooking algorithm 834 or cooking sequence 810. Once the correct number of full rotations has occurred, and the food item is at the respective flipping station, the flipper 62 will activate. For example, at block 916, if the patty is recognized as a veggie burger, the indexing mechanism rotates to a veggie flipper 62a. At block 918 on the other hand, if the patty is recognized as a meat patty, the indexing mechanism rotates to a meat flipper 62b. In both cases, the cooking algorithm 834 or cooking sequence 810 resumes and, at block 920, the grill 10 continues to rotate the until the cooking algorithm 834 or cooking sequence 810 indicates the patty should be finished cooking. In the event that one of the flippers 62a, 62b fails, the other can be used and, if a veggie flipper 62a is used with meat, the veggie patties can be transferred to a center grill (e.g., if provided at the hub 40 area) until the issue is resolved. Once the grill section with that patty has reached the temperature probe station, the temperature probe arm 90 extends to make contact with the patty to take a temperature reading at block 920.

At block 922, if the temperature probe reading indicates that the patty has not yet reached the desired internal temperature, the cooking algorithm 834 or cooking sequence 810 can update to rotate the indexing mechanism such that the patty will travel around the grill again or otherwise continue to be subjected to a heat source for additional time. At block 924, if the temperature probe reading indicates that the patty has reached the desired internal temperature, the cooking algorithm rotates the indexing mechanism such that the patty moves to the ejector station. At block 926, if the patty is recognized as a meat patty, the indexing mechanism rotates until the meat patty is at the meat ejector 700a. If the patty is recognized as a veggie patty, the indexing mechanism rotates until the veggie patty is at the veggie ejector 700b.

At block 930, if the warming bin 140, 150 is detected as being full after the ejection process, the display 160 can notify the user to empty the respective warming bin 140, 150. The grill 10 then continues to rotate until the warming bin 140, 150 has been emptied and replaced. At block 932, the indexing mechanism then rotates such that the grill section where the patty was just ejected is at the cleaner station and the cleaner mechanism 72 operates to clean that grill section. At block 934, the indexing mechanism rotates such that the grill section that was just cleaned is at the patty loading station and the process repeats at block 902. It can be appreciated that at any time during the autonomous operation, if a sub-system fails or a mechanical failure is encountered, an emergency stop button (either mechanical, soft, or both) can be selected to cease movements and allow the grate 30 and hub 40 (if applicable) to be used as a traditional grill.

It can be appreciated from the logic diagram shown in FIG. 19, that the grill sections need not travel through each station in order such that the second patty or food product goes through each station directly after the first patty or food product. That is, depending on the cook times, patties may spend different amounts of time rotating on the indexing mechanism until it is time to move to its next station, thus enabling the grill 10 to execute cooking sequences 810 or cooking algorithms 834 in parallel depending on what food is being cooked. In this way, multiple different types of food products can be cooked at the same time using the same autonomous grill 10.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as transitory or non-transitory storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory computer readable medium which can be used to store the desired information and which can be accessed by an application, module, or both. Any such computer storage media may be part of the autonomous grill 10, system 800, or any component of or related thereto, etc., or accessible or connectable thereto. Any application or module herein described may be implemented using computer readable/executable instructions that may be stored or otherwise held by such computer readable media.

The steps or operations in the flow charts and diagrams described herein are provided by way of example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as having regard to the appended claims in view of the specification as a whole.

What is claimed is:

1. An autonomous cooking grill comprising:
a body supporting a grate with at least one heat source directed towards or coupled to the grate, the grate and at least one tool being moveable relative to one another such that a portion of the grate can be aligned with the at least one tool according to a cooking sequence.

2. The autonomous cooking grill of claim 1, wherein the grate rotates relative to the at least one tool.

3. The autonomous cooking grill of claim 2, wherein a plurality of tools are spaced about the grate.

4. The autonomous cooking grill of claim 1, wherein the at least one tool comprises at least one autonomous flipper.

5. The autonomous cooking grill of claim 1, wherein the at least one tool comprises at least one autonomous ejector.

6. The autonomous cooking grill of claim 1, wherein the at least one tool comprises at least one autonomous grate cleaner.

7. The autonomous cooking grill of claim 1, wherein the at least one tool comprises an autonomous temperature probe.

8. The autonomous cooking grill of claim 1, further comprising an additional cooking surface centrally positioned in a hub surrounded by the grate.

9. The autonomous cooking grill of claim 1, wherein the at least one heat source comprises at least one gas burner to heat the grate.

10. The autonomous cooking grill of claim 1, wherein the at least one heat source comprises at least one electric heat source.

11. The autonomous cooking grill of claim 1, wherein the at least one heat source comprises both gas and electric heat sources.

12. The autonomous cooking grill of claim 8, wherein the additional cooking surface is heated by a first heat source that is different from a second heat source used to heat the grate.

13. The autonomous cooking grill of claim 12, wherein the first heat source is electric and the second heat source is gas.

14. The autonomous cooking grill of claim 1, further comprising a bin capable of holding food.

15. The autonomous cooking grill of claim 1, further comprising a main controller coupled to a plurality of signal inputs and actuator controllers to control actuators and send outputs based on signal inputs.

16. The autonomous cooking grill of claim 15, wherein the main controller is coupled to a detection system to apply a food item recognition program as an input to determine a cooking algorithm.

17. The autonomous cooking grill of claim 1, further comprising a user interface coupled to a control system used in operating the grill.

18. The autonomous cooking grill of claim 1, further comprising at least one data interface to provide cooking log data.

19. The autonomous cooking grill of claim 18, comprising a network data interface for sending log data to a central server.

20. The autonomous cooking grill of claim 1, further comprising an indexing mechanism to determine a position of the rotatable grate.

21. The autonomous cooking grill of claim 1, further comprising a wall positioned on an underside of the body below the grate, the wall separating a relatively hot zone comprising the at least one heat source from a relatively cool zone aligned with areas comprising the at least one tool surrounding the grate.

22. The autonomous cooking grill of claim 1, wherein the at least one heat source is fed by a fuel source, the fuel source being regulated by a modulating valve, the modulating valve being computer controlled and being connected to an inlet fuel line, wherein a heat sensor is configured to measure a temperature of at least a portion of the grate, the temperature being used to control the modulating valve.

23. The autonomous cooking grill of claim 18, wherein the heat sensor provides a temperature reading to a controller and the controller uses the temperature reading to control the modulating value to vary an amount of fuel being delivered to each of the at least one heat source to increase or decrease the temperature of the grate.

24. A system comprising:
at least one autonomous cooking grill according to claim 1;
a network interface coupled to each of the at least one autonomous cooking grill to obtain data generated by each grill; and
a central server coupled to each cooking grill via a respective network interface to exchange data with the respective grill.

25. A method comprising:
detecting placement of food to be cooked on an autonomous cooking grill according to claim 1;
detect type of food product;
determine a cooking algorithm per detected type of food product; and
rotate grill according to cooking algorithm.

26. The method of claim 25, further comprising:
when cooking has completed, rotate to an ejection zone if necessary and activate an ejector tool.

27. The method of claim 25, further comprising aligning the food product with a flipper tool and flipping the food product at an indicated time during the cooking algorithm.

28. The method of claim 25, further comprising aligning the food product with a temperature probe to determine a temperature of the food product during execution of the cooking algorithm.

29. The method of claim 25, further comprising aligning a grate on which the food product was placed with a scraper tool and activating the scraper tool to clean the grate for a next cooking iteration.

30. The method of claim 25, further comprising aligning the food product with a particular warming bin according to the type of food product.

31. A computer readable medium comprising computer executable instructions for:
detecting placement of food to be cooked on an autonomous cooking grill according to claim 1;
detect type of food product;
determine a cooking algorithm per detected type of food product; and
rotate grill according to cooking algorithm.

32. An autonomous cooking grill comprising a body supporting a grate with at least one heat source directed towards or coupled to the grate, the grate being rotatable in a clockwise and/or counterclockwise direction.

33. The autonomous cooking grill of claim 32, further comprising an indexing mechanism to determine a position of the rotatable grate.
